(19) United States
(12) Patent Application Publication
(10) Pub. No.: US 2006/0183099 A1
(43) Pub. Date: Aug. 17, 2006

(54) EDUCATION AND TEST PREPARATION SYSTEM, METHOD AND COMPUTER PROGRAM PRODUCT

(76) Inventors: Richard A. Feely, Flossmoor, IL (US); Sebastian Palmigiani, Chicago, IL (US)

Correspondence Address: BARNES & THORNBURG, LLP, P.O. BOX 2786, CHICAGO, IL, 60690-2786, US

(21) Appl. No.: 11/276,072

(22) Filed: Feb. 13, 2006

Related U.S. Application Data
(60) Provisional application No. 60/652,755, filed on Feb. 14, 2005.

(51) Int. Cl. G09B 7/00

(52) U.S. Cl. 434/323

(57) ABSTRACT

A test study and preparation system, method, and computer program product. Questions are displayed on a user interface that may be keyed to one or more publications or examinations, in particular, to publications or credit-earning boards or examinations on traditional Chinese Medicine, acupuncture, and related arts. A correct answer may be displayed when a question is answered incorrectly with corresponding annotation information about where the correct answer is found in the keyed publication. The system is connected to a plurality of user interfaces over a communications network to allow dispersed study and review. Statistics about accuracy of responses is monitored and displayed by the system. Daily questions or study tips may be transmitted to subscribers. Flashcards study systems may also be displayed.

### RELATED APPLICATION

This application claims the benefit of U.S. Provisional Application No. 60/652,755 filed Feb. 14, 2005, the disclosure of which is hereby incorporated by reference in its entirety.

### BACKGROUND AND SUMMARY

The present disclosure relates to a system, method, and computer program product for education test preparation and certification.

In particular, the present disclosure is directed to providing education and testing materials in the field of traditional Chinese medicine (TCM) to users via a communication network such as the Internet through an interactive website and web-based interface. A user is able to access a number of quizzes on a variety of topics through a series of drop down menus, answer questions contained in the quizzes, and receive feedback on the correctness of those answers. Reference is made to corresponding source materials or textbooks. Thus, the present disclosure may be used for a variety of purposes including, but not limited to general study and memorization of factual material, test preparation for examinations administered by schools, accrediting agencies and the like, and the administration of tests in order to receive accreditation or certification completion.

The present disclosure relates to a system, method, and computer program product that allows a user to access educational and test preparation material over a communications network. The user may also answer questions and receive feedback to test the user's knowledge of particular subject matter. The present disclosure also relates to a method by which a party can administer an examination to a user via an interface over a communications network.

Additional features and embodiments will become apparent to those skilled in the art upon consideration of the following detailed description of drawings.

### BRIEF DESCRIPTION OF THE DRAWINGS

The present disclosure will be described hereafter with reference to the attached drawings which are given as a non-limiting example only, in which:

FIG. 1 depicts a home web page for an embodiment of the present disclosure;

FIG. 2 depicts a login web page;

FIG. 3 depicts a web page for purchasing subscriptions;

FIG. 4 depicts a members page;

FIG. 5 depicts a quiz index page;

FIG. 6A depicts part of a quiz menu page;

FIG. 6B is a continuation of the quiz menu page of FIG. 6A;

FIG. 6C is another embodiment of a quiz menu page;

FIG. 6D depicts details of the quiz menu page of FIG. 6C;

FIG. 6E depicts a quiz graph window;

FIG. 7A depicts a quiz window superimposed over the quiz menu page of FIG. 6B;

FIG. 7B depicts a quiz window providing feedback;

FIG. 7C depicts a quiz window after completion of the quiz;

FIG. 7D depicts a quiz window with a non-text question area;

FIG. 7E depicts an interactive quiz window;

FIG. 7F shows the feedback feature of the interactive quiz window of FIG. 7E;

FIG. 7G is an alternative embodiment of the quiz window of FIG. 7B;

FIG. 8 depicts a book index page;

FIG. 9 depicts a book menu page;

FIG. 10 depicts a NCCAOM index page;

FIG. 11A depicts a NCCAOM menu page for acupuncture;

FIG. 11B is a continuation of the NCCAOM menu page of FIG. 11A;

FIG. 12A depicts a herb menu page;

FIG. 12B is another embodiment of FIG. 12A;

FIG. 12C is yet another embodiment of FIG. 12A;

FIG. 13A depicts a biomedicine menu page;

FIG. 13B is a continuation of the page of FIG. 13A;

FIG. 14 depicts a treasure chest page;

FIG. 15 depicts a points book page;

FIG. 16 depicts a points atlas page;

FIG. 17 depicts a points table page;

FIG. 18 depicts a quality control page;

FIG. 19 depicts a logout page;

FIG. 20 is a block diagram for an embodiment of the present disclosure;

FIG. 21 is another embodiment of a module score summary page;

FIGS. 22-25 are continuation of the embodiment of FIG. 21, displayed by scrolling down the module score summary page;

FIG. 26 is a page for selecting a board examination;

FIG. 27 is a chapter study test statistics page;

FIG. 28 is a section selection page;

FIG. 29 is points action page;

FIG. 30 is a user feedback page;

FIG. 31 is a user subscription page;

FIG. 32 is a user login page;

FIG. 33 is a home page, displaying board dates, a selection of boards, and a what's new section.

FIG. 34 is an interface showing a graphical representation of test answer results;

FIG. 35 is a sample tests page;

FIG. 36 is an exemplary test question with associated anatomical illustration, where a user can answer the question by positioning a dot on the illustration;

FIG. 37 is an exemplary screen shot shown in response to an incorrect location being selected.

FIG. 38 is an exemplary test question where an anatomical location is shown by a dot and the user must select to the corresponding anatomical location description;

FIG. 39 is a subscription selection web page;

FIG. 40 is an example of an acupuncture test question;

FIG. 41 is an example of feedback provided in response to an incorrect answer, including striking through the other incorrect answers and displaying an annotation to the a publication;

FIG. 42 is a page showing test results and providing an option to retake only questions answered incorrectly;

FIG. 43 is an information page; and

FIG. 44 is a flashcard page of the study section.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

While it is recognized that embodiments of the present disclosure generally relate to TCM subject matter for the content of the educational and testing material, it should be apparent to one skilled in the art that the present disclosure may be adapted to virtually any field of study or profession where learning and testing can be delivered via a web-based interface.

The present disclosure discloses comprises one or more of the features or combinations thereof disclosed above or in the Detailed Description herein. It should be understood that the following description is illustrative and in no way limits the scope of the disclosure as described. While the embodiment of the disclosure described herein is related to a system of education and testing in the field of traditional Chinese medicine (TCM), it should be understood that the present disclosure is applicable to any field of study requiring education and test preparation.

The field of traditional Chinese medicine (TCM) generally relates to oriental medicine, acupuncture, herbology, and Asian bodywork therapy. Practitioners of TCM undergo a course of study to learn the art and may receive accreditation from an accrediting organization upon satisfactory demonstration of proficiency in the field of TCM. One such accrediting organization is the National Certification Commission for Acupuncture and Oriental Medicine (NCCAOM). The NCCAOM, as is typical of many accrediting organizations in various fields, requires applicants to pass an examination to receive credentials. NCCAOM also provides continuing education credit for credential holders to maintain proficiency in the field. Although NCCAOM is identified, the present disclosure may be used with other accreditation bodies as well.

For both examinations and continuing education credit, the person seeking the credential typically must study for and pass an examination. A user accesses educational data through a website portal using a computer device and associated peripheral devices (collectively “computer”) that are connected to a communications network as is generally known in the art. Once the user has accessed the portal, the user is able to select quizzes on various topics and sub-topics from various menus.

Once the user selects the subject matter of the quiz, the web browser displays a question with a plurality of answer choices. The user selects one of the answer choices by clicking on a radio button, check box, hyperlink, or similar means known in the art. The user then has the option to submit the answer or to change it. The user may only submit one answer choice. Once the answer choice is submitted, the user receives instant feedback on whether the answer choice was the correct one. The user may also see a running total of the number of questions answered correctly and the total number of questions. Alternatively, the system may not provide feedback until the user has answered all quiz questions.

In addition to accessing questions and submitting answers, the user may also access reference and/or study materials without having to provide answers to questions. The reference sections of the system may be organized by subject matter and contain textual, graphic, other information related to the particular field, or contain a citation to associated materials.

Generally, the system of the present disclosures may be accessed through a home page display on a web-browser. A user may access the home page for the provider of the educational and testing materials by typing the appropriate uniform resource locator (URL) address into the address box of a typical web browser known in the art. To access the educational and testing materials, the user may have to first subscribe to the website by clicking on a hyperlink taking the user to a subscription page.

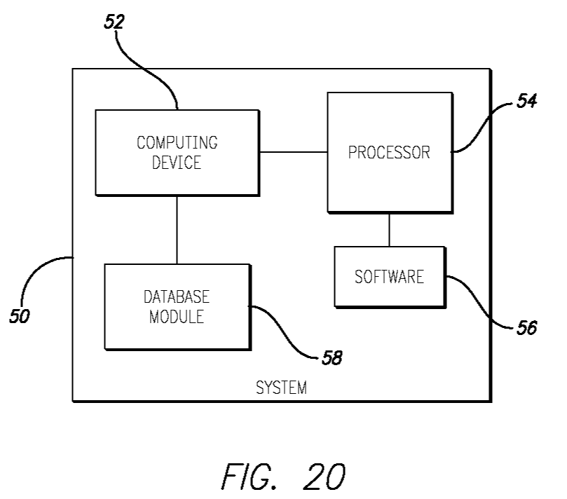

The present disclosure is for a method of providing an educational and test preparation tool to a user over a communications network. A simple block diagram is shown in FIG. 20. The method includes providing a system 50 that includes a general purpose computer 52 having a processor 54 operating by one or more software modules 56, including one or more database modules 58.

The term “computer module” or “software module” referenced in this disclosure is meant to be broadly interpreted and cover various types of software code including but not limited to routines, functions, objects, libraries, classes, members, packages, procedures, methods, or lines of code together performing similar functionality to these types of coding. The components of the present disclosure are described herein in terms of functional block components, flow charts and various processing steps. As such, it should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, SQL, C++, Java, COBOL, assembler, PERL, or the like, with the various algorithms being implemented with any combination of data structures, objects, processes, routines or other programming elements. Further, it should be noted that the present disclosure may employ any number of conventional techniques for data transmission, signaling, data processing, network control, and the like as well as those yet to be conceived.

System 50 allows a user to access information residing on a system 50 over a communications network as is known in the art. System 50 may be connected to the Internet, connected to a local area network (LAN), connected to another public or private proprietary network, or be stand-alone.

A database module 58 contains educational material for the system 50 of the present disclosure. The educational and testing materials may be delivered to the user via a website or similar portal having a plurality of web pages, and accessed by the user through a conventional browser. The user is able to select from among a plurality of categories and topics to receive educational information and testing related to the chosen areas of interest. The quizzes are compiled from a database of questions residing on a server. Generally, each quiz contains a number of questions that is a subset of the total number of questions contained within the database. The subset may be randomly selected from the complete database. This is to ensure that the user answers the question from retained knowledge and simply does not mimic the answers to recycled questions. Additionally, the database should contain a large number of questions, preferably in the thousands or tens-of-thousands. This ensures user does not merely memorize answers to repeated questions.

In an embodiment of the present disclosure, the substantive content of the website is protected, requiring the user to enter a username and password before being allowed to use the system 50. User information is contained within database module 58. After the user submits a username and password the system 50 verifies the information provided by the user with the information contained in database module 58. If the user information is verified, the user is allowed access to the website.

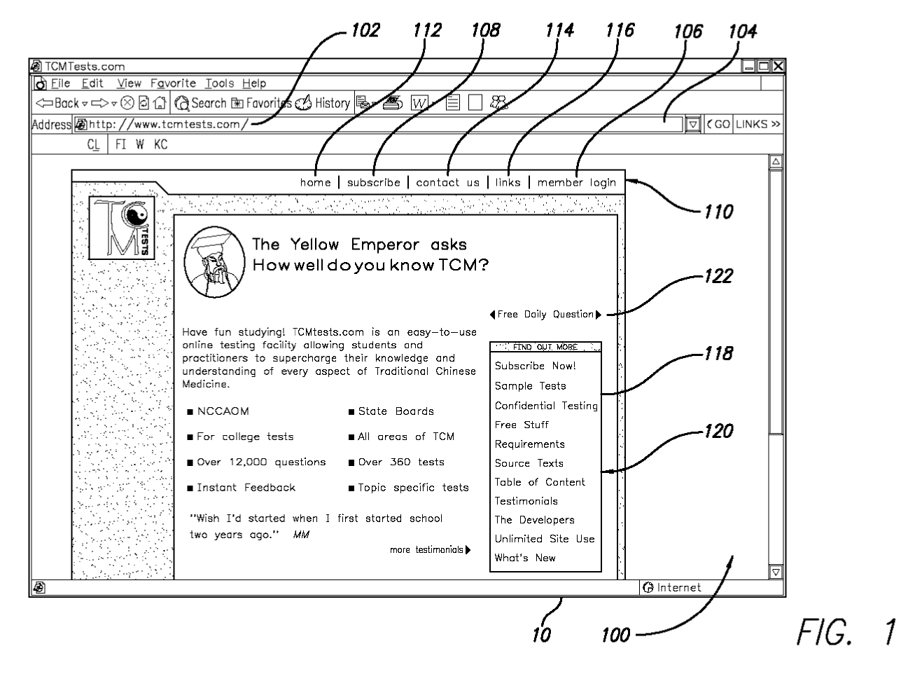

Referring to FIG. 1, a user may access home page 100 of the system 50 to access educational and testing materials by typing the appropriate uniform resource locator (URL) 102 address into the address box 104 of a typical web browser 10 known in the art. The home page 100 provides general information about the content of the website.

In addition to typing a URL into the browser 10, the user may access the home page 100 by any means known or yet to be developed in the art. Such means presently include choosing a bookmark from a menu, clicking on a referring link, using a search engine, or other similar means.

FIG. 1 depicts a home page 100 for an embodiment of the present disclosure. A menu 110 allows a user to access other web pages on the site. The embodiment shown in FIG. 1 has a navigation menu bar 110 with a plurality of hyperlinks 106, 108, 112, 114, 116 that allows the user to access the home page 112; purchase a subscription to the website 108; contact the operators of the website 114; access links of related subject matter 116; and log in 106. As will become apparent, generally each web page has a menu bar similar to menu bar 110 allowing the user to navigate the website. The embodiment of FIG. 1 also has an informational menu 118 with hyperlinks 120 to web pages containing informational and promotional materials. Finally a hyperlink 122 is available to allow a user to sign up for a free daily question, delivered by email to the user, that is similar to the questions provided in the quizzes.

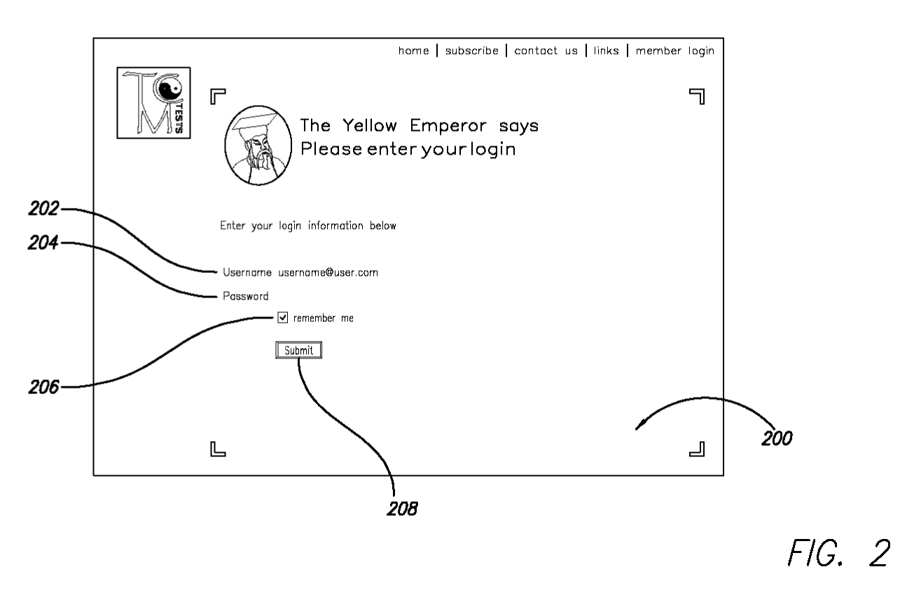

To access the substantive educational and testing materials content, the user may first need to log in. A member login hyperlink 106 on the home page 100 takes the user to a login page 200 shown in FIG. 2. The login page has fields for the user to enter a username 202, and password 204. The user may also select an option 206 for the web page to “remember” that particular user. This may be accomplished by a “cookie” as is known in the art. The cookie allows the website computer to recognize the user's computer without the user having to re-enter the username and password. Once the username and password have been entered, the user clicks the “submit” button 208 to send the username and password to the system 50 for verification. Once the username and password have been verified, the user is allowed to access the areas of the website containing substantive subject matter.

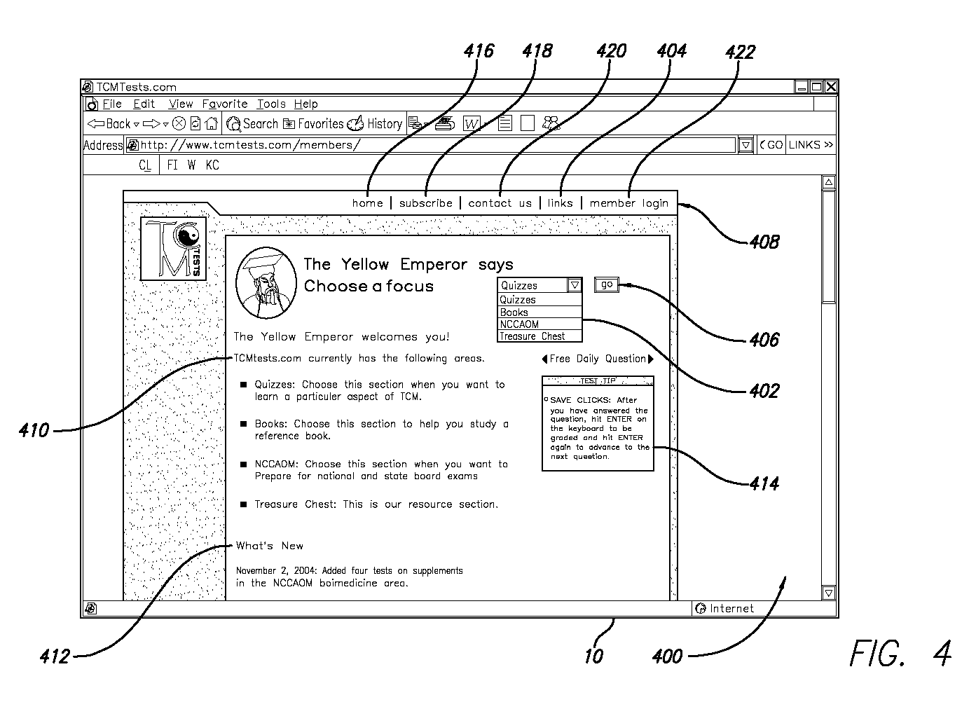

If the user enters incorrect information, for example if there is a typographical error in either the username or password, or if the user is not a registered subscriber, the system 50 will generate a screen with an error message. If the user enters information that the system 50 verifies as a registered user, the web browser displays a welcome page 400. An embodiment of such a welcome page 400 is shown in FIG. 4.

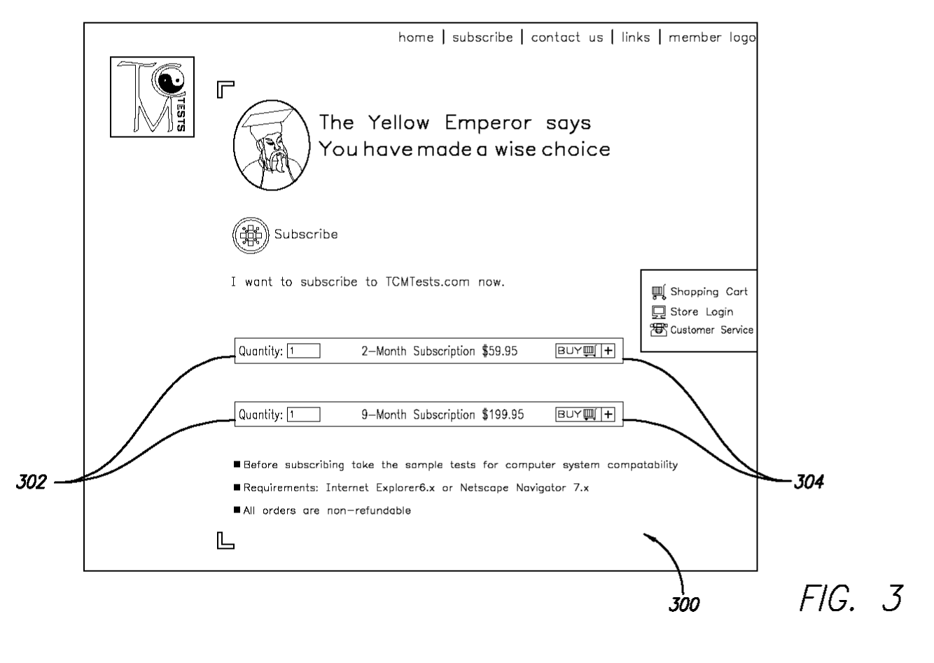

The user must register in order to obtain a username and password. In an embodiment of the present disclosure, a user must purchase a subscription to gain access to the substantive material. In another embodiment, the user merely needs to register without a purchase. The user may subscribe to the website by clicking on a subscribe hyperlink 108 as shown in FIG. 1. which takes the user to a subscription page 300 as shown in FIG. 3.

Referring to FIG. 3, the user may choose from a number of subscription plans depending on the length of time that the user intends to access the website and the amount of money that the user wishes to spend. The embodiment shown in FIG. 3 allows the user to choose from between two subscription plans, although is should be apparent that an unlimited number of different subscriptions may be made available. The first option is for a two-month subscription at a certain price. The second option is for a nine-month subscription at a second price, generally higher than for the first option. The user is able to input the number of subscriptions desired 302 and then select a button 304 to purchase the subscription. The user is then prompted for personal information such as name, address, email address, etc. Once the personal information has been entered, the user is prompted for a password. The user receives feedback displaying the newly created username and password. The user may then continue where he will be prompted for credit card information. The cost of the subscription is billed to a credit card account number supplied by the user. Finally, the browser 10 will display a summary page and allowing the user to complete the transaction. After the user has purchased a subscription and received a username and password, the user will be able to access the areas of substantive information on the website.

The substantive portion of the materials accessible on system 50 may be organized into a hierarchy having a structure from general areas of interest called “focus areas” to more narrow categories within each focus area. The focus areas are directed towards a general area of study. As shown in FIG. 4, the welcome page 400 prompts the user to select a focus category from a menu 402. Alternatively, the user may select a focus by clicking on a focus hyperlink 404 contained in the menu bar 408 at the top of the welcome page 400. Included in the hierarchy under the focus areas are additional categories that become narrower in scope with greater level of detail going down the hierarchy. The additional categories may be referred to in descending order as “main topics”, “specific topics”, and “sub-topics”. It should be obvious to one skilled in the art that an educational web site may be designed with any number of levels to the hierarchy and with any number of categories within each level.

The welcome page 400 may have a brief outline 410 of the focus areas website. There is also an area 412 for information and updates. An area 414 with help or tips is also provided. Menu bar 408 has a plurality of hyperlinks 404, 416, 418, 420, 422. In the embodiment shown in FIG. 4, the menu hyperlinks on the member welcome page 400 are: “home” 416; “subscribe” 418; “contact us” 420; “focus” 404; and “member logout” 422. Selecting “home” will take the user back to the home page 100. Selecting “subscribe” will take the user to a subscription page 200 where the user may purchase a subscription or extend an existing subscription to the system 50. Selecting “contact us” 420 provides information to contact the operators of the website including e-mail address and postal address. Selecting “member logout” 422 logs the member out of the website. The user may display substantive content by selecting the “focus” link 404. Alternatively the user may select substantive content through another type of menu.

In one embodiment of the present disclosure, the user may choose from a list of focus areas. For example, as shown in the drop-down type menu 402 in FIG. 4, the four focus areas are “Quizzes”, “Books”, “NCCAOM”, and “Treasure Chest”. The user selects one of the focus areas from the menu 402 and clicks on a “go” button 406 or other link to display the web page with that information.

In another embodiment of the present disclosure, the “Quizzes” focus area is replaced by “Boards” and the “NCCAOM” focus area is replaced by “College”. The “Boards” area is formatted to provide questions of the type found on licensure and certification examinations, such as those administered by NCCAOM and other certifying and licensing organizations. The “College” area is formatted to facilitate learning the subject matter as part of the study process as for a credit course.

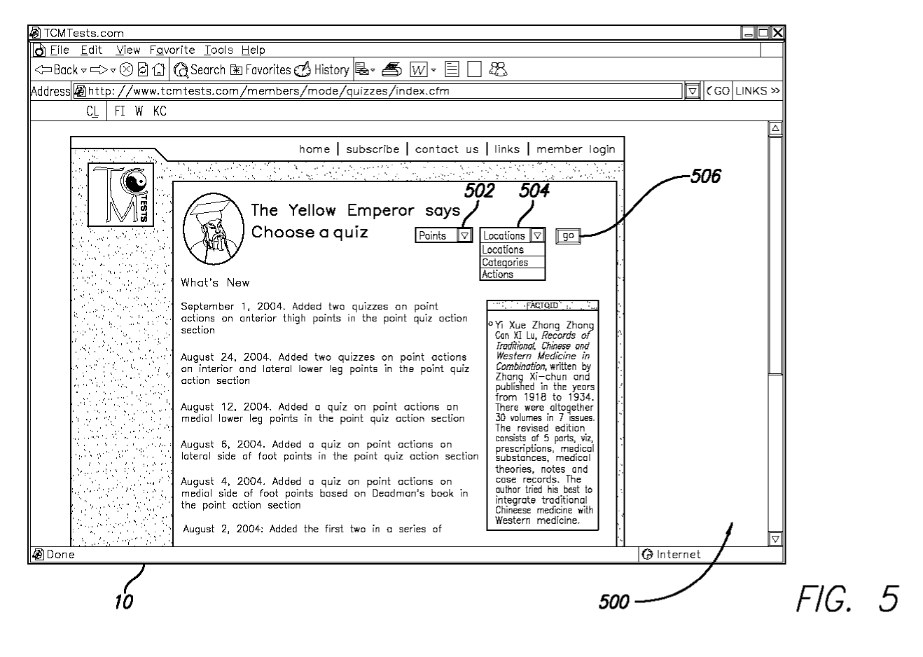

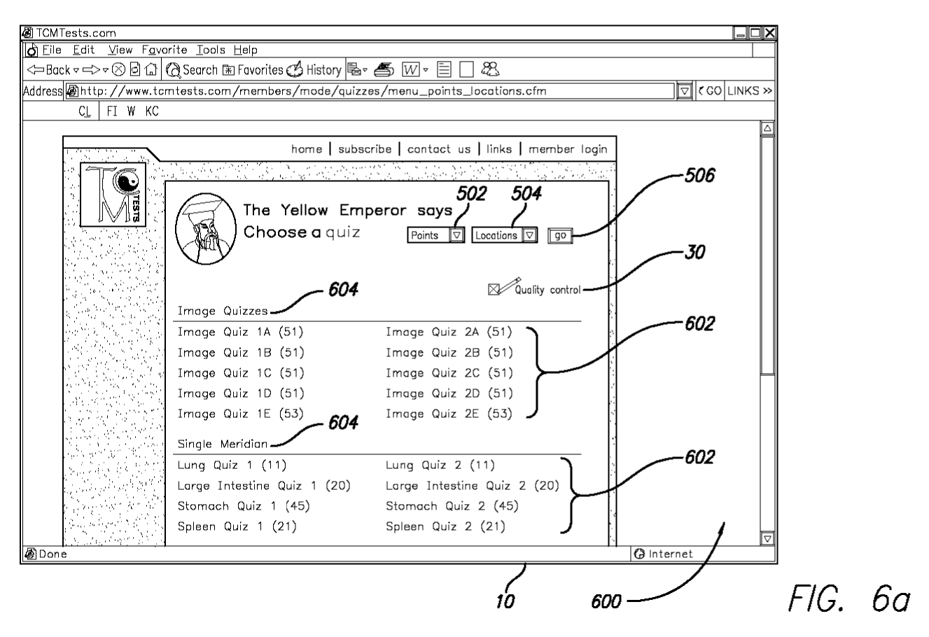

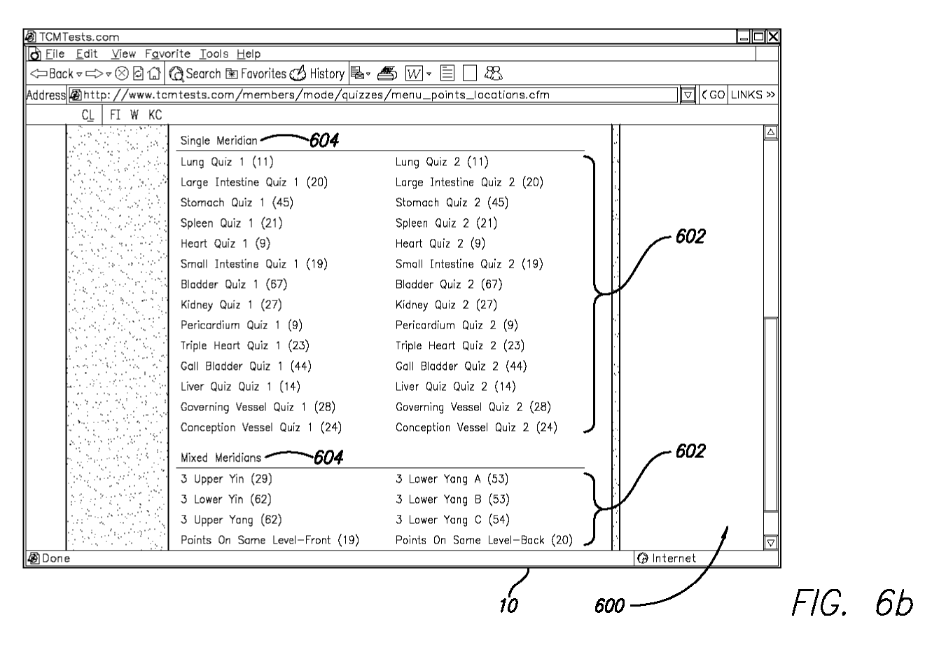

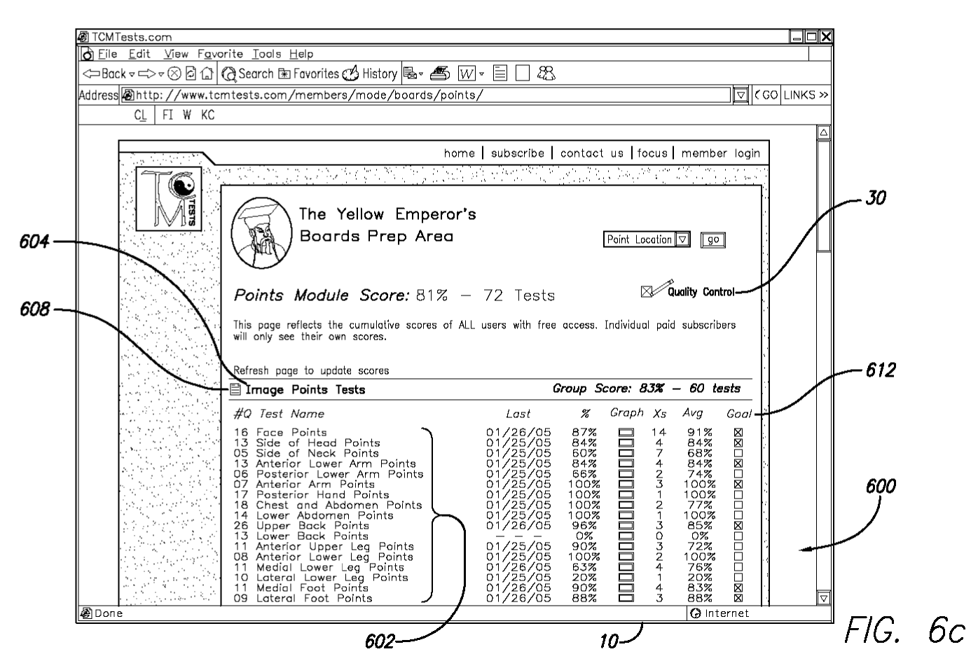

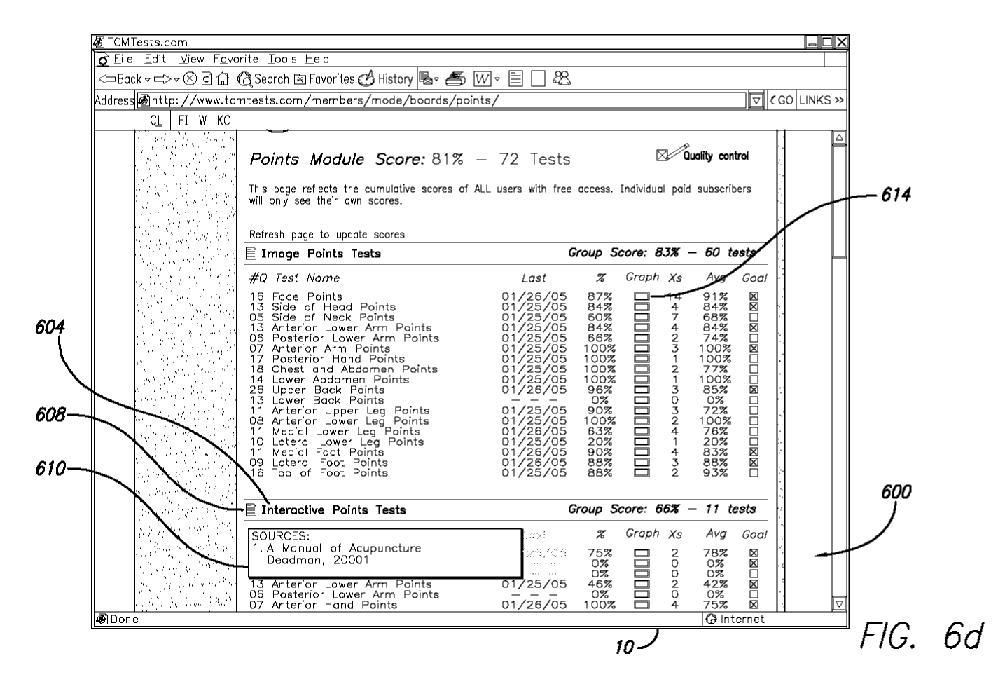

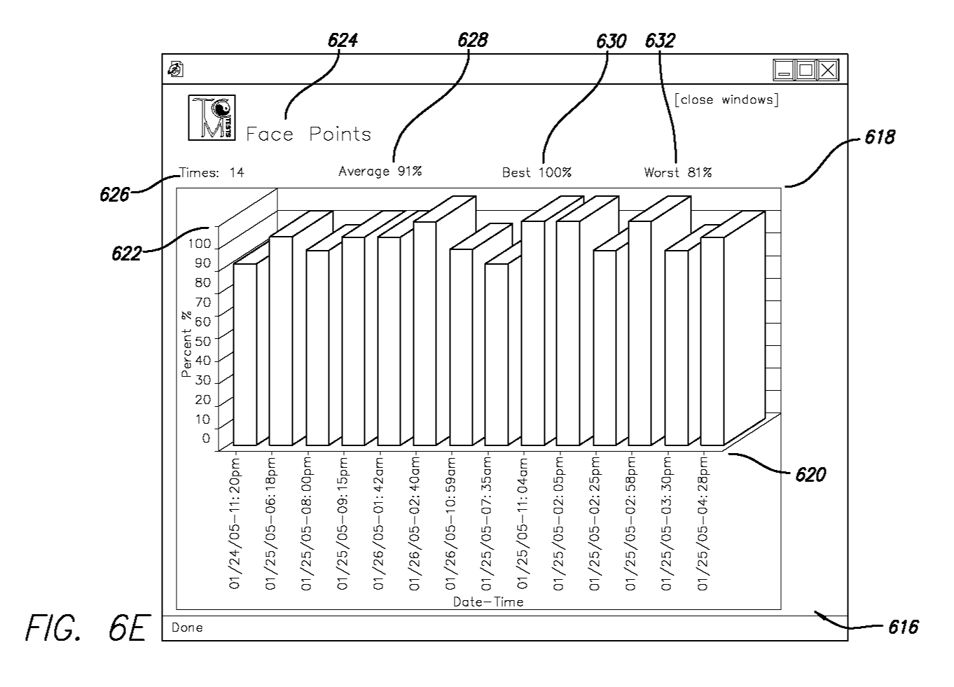

If the user selects “Quizzes” from the menu, the browser 10 displays a web page asking the user to select a narrower main topic on which the quizzes are based. This quiz index page 500 as shown in FIG. 5, has a menu allowing the user to choose the subject matter for the quiz. For example, the embodiment shown in FIG. 5 has a first pull-down menu 502 displaying main topics for the quizzes, and a second pull-down menu 504 displaying the specific topics. The user selects from main quiz topics from the first pull-down menu 502, and a specific quiz topics from the second pull-down menu 504. The user then clicks on a button 506 or other link to display a quiz menu page 600 as shown in FIGS. 6A and 6B. The quiz menu page 600 displays a number of links 602 grouped by sub-topic 604. Each link briefly describes the subject matter of the particular quiz. Also, the user may choose a different quiz topic by selecting from the first pull down menu 502 and the second pull-down menu 504 and then clicking on the button 506 as described previously.

In one embodiment of the present disclosure, the first pull-down menu 502 displays the following main topics for the user to choose from: Points, Herbs, and Theory. If the user selects “Points” in first pull-down menu 502, the following specific topics are displayed in second pull down menu 504: Location, Categories, and Actions.

For example, the “Points” main topic is generally directed towards locations on the body, which according to TCM, have the ability to affect other bodily systems through the application of certain techniques, such as, for example, acupuncture. The user may select from the specific topics of “Location”, “Categories”, and “Actions”. As shown in FIGS. 6A and 6B, the Points-Location quizzes are arranged by sub-topic 604: Image Quizzes, Single Meridian, and Mixed Meridian. Under each sub-topic are links for specific quizzes related to the particular sub-topic.

The embodiment of the present disclosure shown in FIG. 6C is another example of a quiz menu page 600. In this embodiment, quiz menu page 600 has information icons 608 adjacent to the sub-topics 604. When the user moves the cursor over the information icon 608, a text box 610 appears as shown in FIG. 6D. Text box 610 contains information about the sources of information for the questions contained in the quizzes or tests under the particular subtopic. This feature is useful for learning and test preparation because it allows the user to reference an outside source for the substantive subject matter.

The embodiment shown in FIG. 6C also contains data 612 for quizzes taken. The system 50 stores data for each quiz taken in a database module 58. In the subscription mode, this data shows the scores only for the user currently logged in. In the public access mode, this data shows scores of all users. The data includes the date when the particular quiz was last taken; the percent correct on the last quiz taken; a graph showing the percent correct on quizzes taken along with the date and time; the number of times a particular quiz has been taken; the average score for that quiz; and an indication of whether a predetermined goal has been reached.

Each quiz has a graph icon 614. When the user clicks on the graph icon 614, a graph window 616 opens, as shown in FIG. 6E. Using stored data, the system 50 constructs a graph 618 of scores for a particular quiz. The name of the quiz 624 may appear in the graph window. The particular embodiment shown in FIG. 6E uses a bar graph, however it should be understood that any graphical representation is contemplated by the present disclosure. The graph of FIG. 6E is constructed along an X-axis 620 having the date and time of each test taken, and a Y-axis 622 having percent correct. Since the graph 618 displays scores in chronological order, this is a particularly useful tool for a user to evaluate his or her progress in a particular subject area. The graph window 616 may also contain other data such as the number of times a particular quiz has been taken 626; the average score 628; the best score 630; and the worst score 632.

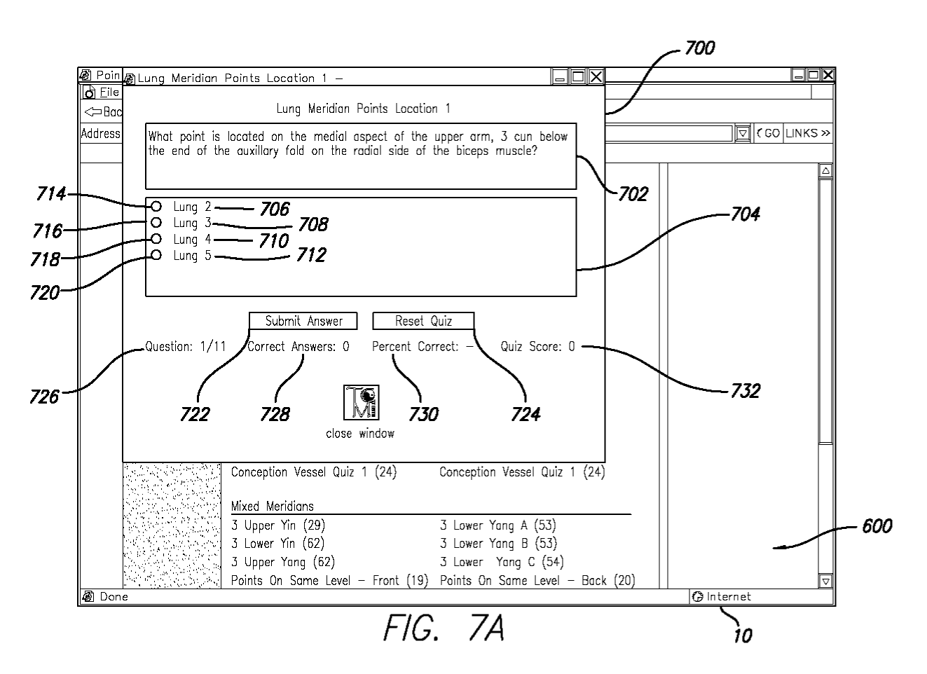

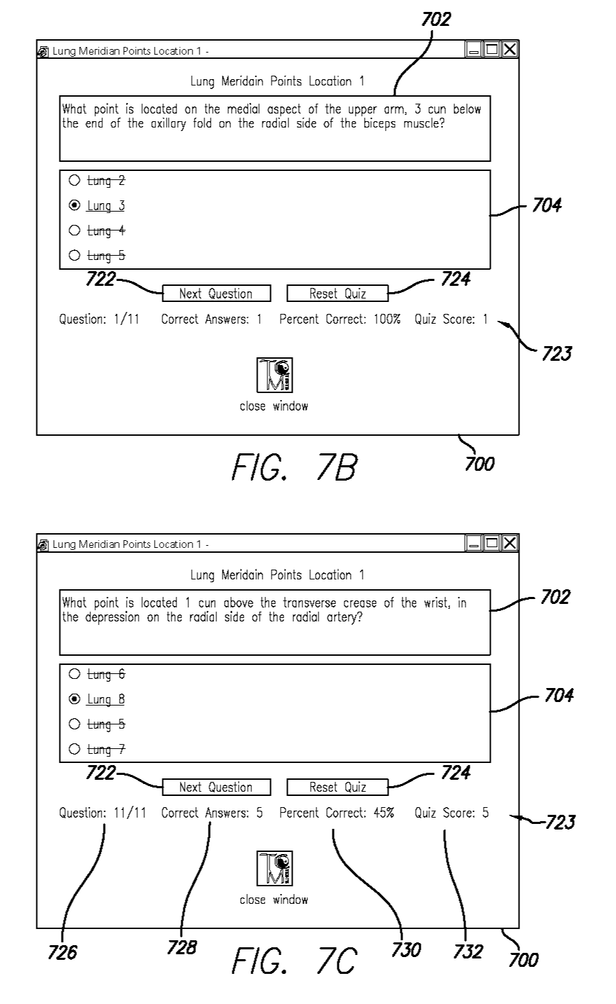

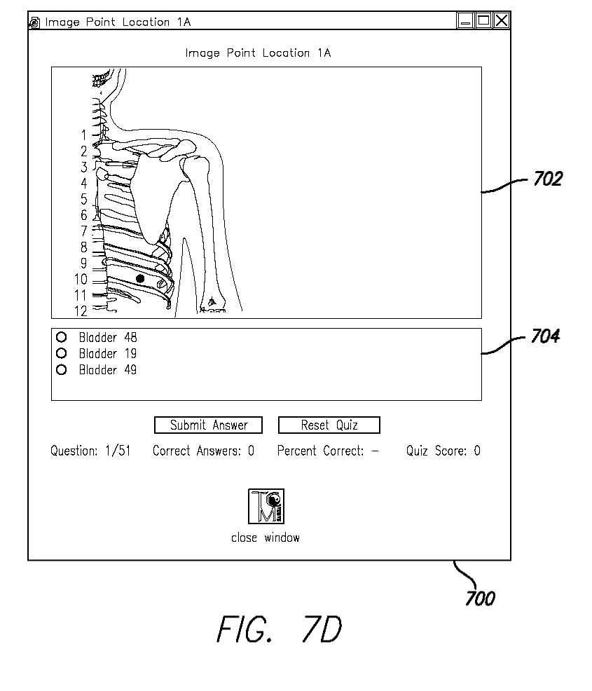

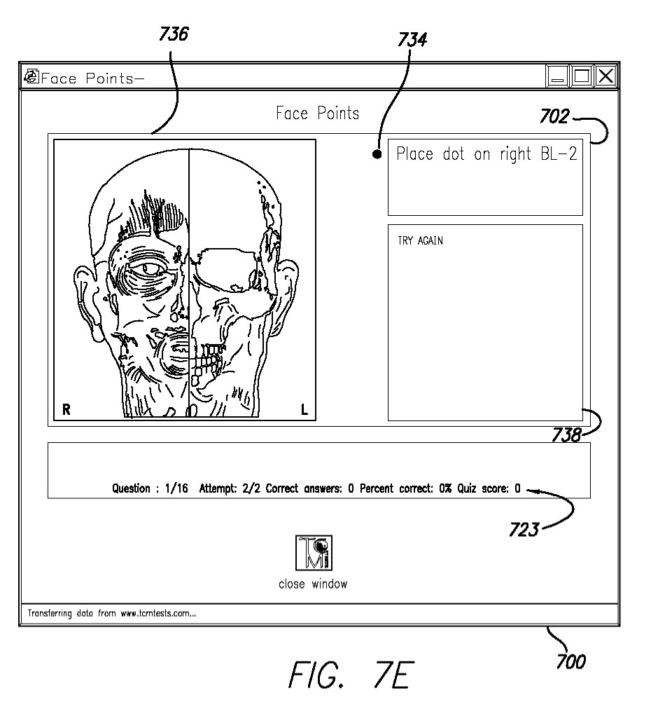

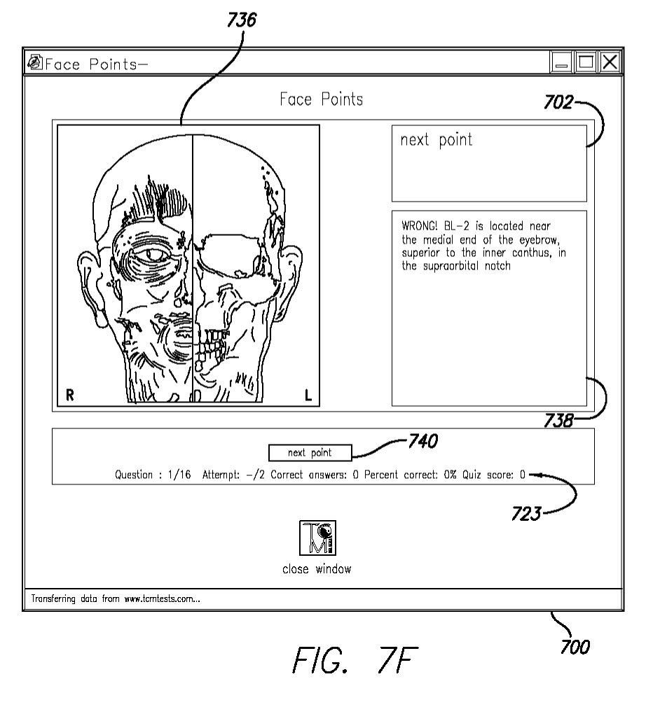

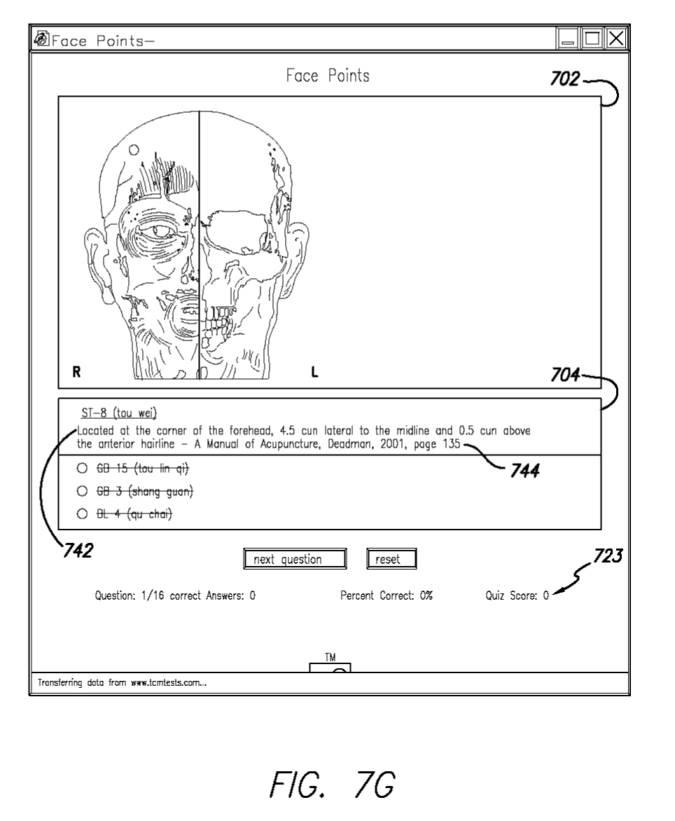

When a user clicks on a link for a particular quiz, a quiz window 700 is displayed as shown in FIG. 7A. In the embodiment shown, the quiz window 700 is superimposed over the web browser window 10 already operating and displaying the quiz menu page 600. It should be apparent that an equally acceptable method is to have the quiz window 700 replace the quiz menu page 600 in the operating browser window 10.

The quiz window 700 has a question portion 702 which displays a question selected from database module 58 of questions. The quiz window 700 also has an answer portion 704 which displays a plurality of answer choices 706, 708, 710, 712 and a plurality of radio buttons 714, 716, 718, 720 corresponding to the answer choices. While the embodiment shown in FIG. 7A depicts four answer choices and four radio buttons, it should be apparent that the number for both may vary and still be within the scope of the present disclosure. For example an answer portion may contain only two answer choices with their associated radio buttons for “true/false” type questions. Furthermore, typical multiple choice tests have from three to five answer choices per question, although the present disclosure can accommodate any number.

The system 50 generates questions from database module 58. The database module 58 may contain thousands or tens-of-thousands of available questions. A system having a large number of questions is more likely to provide better practice for the user and better evaluation to an administrator for numerous reasons, such as that the user would be less likely to memorize answers to a few questions. An embodiment of the present disclosure can contain a database with over 12,000 questions.

The user selects an answer from the plurality of answer choices 706, 708, 710, 712 by clicking on one of the corresponding plurality of radio buttons 714, 716, 718, 720. Before the user has selected an answer choice, button 722 may be inactive. However, once the user selects an answer choice, button 722 becomes active displaying the text “Submit Answer.” The user may change the selected answer choice at any time before clicking on button 722. Once the user clicks on button 722, the user is provided with feedback on the correctness of the answer chosen. In the embodiment shown in FIG. 7B, the feedback is provided in the form of incorrect answer choices appearing in strikethrough text, while the correct answer choice appears in underlined text. Furthermore, the user's answer choice is displayed by a darkened radio button. In another embodiment shown in FIG. 7G, in addition to the feedback described above, a the correct answer choice is displayed along with a description 742 of the correct answer. A citation 744 to a reference source for the answer may also be provided.

The user is also provided with statistics 723 related to the quiz as a whole. For example, as shown in FIG. 4C, the user is informed of the number of the question 726, the number of correct answers 728, the percent correct 730 and the quiz score 732. The user may start over for the particular quiz by clicking on the reset button 724 which will return the score to zero and number the next question displayed as question one. Note that in FIG. 7B, button 722 displays the text “Next Question.” Clicking on button 722 after receiving feedback will take the user to the next question, at which time button 722 will be inactive until the user selects an answer choice wherein button 722 will become active again allowing the user to submit the answer chosen. The function of button 722 alternates in this manner until the last question of the quiz is submitted, at which point button 722 is to restart the quiz at question one as noted by the text “Restart Quiz,” see FIG. 7C. After all quiz questions are answered, the user is provided with the statistical information of the performance on that quiz, such as the number of correct answers, the percent correct and a quiz score.

Referencing FIG. 7D, the question portion 702 of quiz window 700 may contain information other than simple text questions. The example shown in FIG. 7D has an image in question portion 702 displaying a point location which the user is asked to identify by selecting one of the answer choices in the answer portion 704. In addition to illustrations, image questions may include photographs, movies such as MPEG files, and any other graphical representation of information.

Another embodiment employs an interactive quiz. For example, as shown in FIG. 7E, question portion 702 contains instructions for the user to place a marker 734, in this example a dot, onto a specified point on an image portion 736. The user moves the marker 734 onto the image portion 736 by clicking and dragging with the mouse cursor to the desired spot and then releasing. After the user has moved the marker 734 to the image portion 736, a feedback message appears in a feedback portion 738. If the user has not identified the correct point, the feedback message will instruct the user to try again up to a predetermined number of attempts. In this example, the user is allowed two attempts to correctly place the marker 734 onto the image portion 736. If all attempts to place the marker have been unsuccessful, the feedback portion 738 displays that the attempts are wrong along with a description the correct location of the point location requested by the quiz. See FIG. 7F. If an attempt is successful, the feedback portion 738 displays a message indicating success along with a description of the correct location requested by the quiz. After the user has either exhausted all of his or her attempts, or has successfully answered the question, a button 740 is displayed which the user must click to move on to the next question. The embodiment of FIGS. 7E and 7F also may display quiz statistics 723 as described above.

The quizzes operate in at least two modes. One mode allows the user to complete the entire quiz before the system 50 provides feedback such as showing a score and correct answer. This mode may used to administer a graded test to a user such as for academic credit, accreditation, or certification. This mode may also be used by the user to simulate a test under typical examination conditions. Another mode provides the user with feedback showing the correct answer as soon the user answers a question. This mode may be used by a student to practice the material as part of the learning and study process.

In another embodiment, the present disclosure may be used for certification or accreditation purposes. There are many instances where an individual must pass an examination before becoming certified, accredited, or otherwise receiving a credential. Examples include the registration examination to practice before the U.S. Patent and Trademark Office, state bar exams, medical board exams, licensing examinations, and certification examinations. An embodiment of the present invention may be used to provide certification testing over the Internet through a web-based interface. If the user answers a predetermined number of questions correctly, the user will have passed the examination and attained certification. An embodiment of the present disclosure then provides the user with an electronic copy of a certificate which the user may then print out or save to the user's computer hard drive, disc, or other storage device or digital storage media. The certificate may be of the format traditionally used for diplomas, awards and the like and may bear a signature of one or more officials of the certifying organization, or in the event qualified officials or experts are administering system 50, a signature of such a system administrator.

In yet another embodiment of the present disclosure, the system 50 records the test scores for a given user. System 50 may track the scores to provide the user with an indication of progress, or may be used in connection with earning credit for degree or continuing education programs. In the case of progress tracking, a user may take one quiz repeatedly, or take a series of different quizzes, or some other combination of quizzes designed to evaluate progress. In the case of earned credit, typically a quiz or test is administered to the user, system 50 records the user's score, and if the score surpasses a predetermined threshold, the user will be deemed to have passed and receive credit. An instructor may use an embodiment of the present disclosure to administer one or more tests to students in a class for evaluation and grading. An embodiment of the present disclosure may also be used to award continuing education credit to users upon completion of training modules.

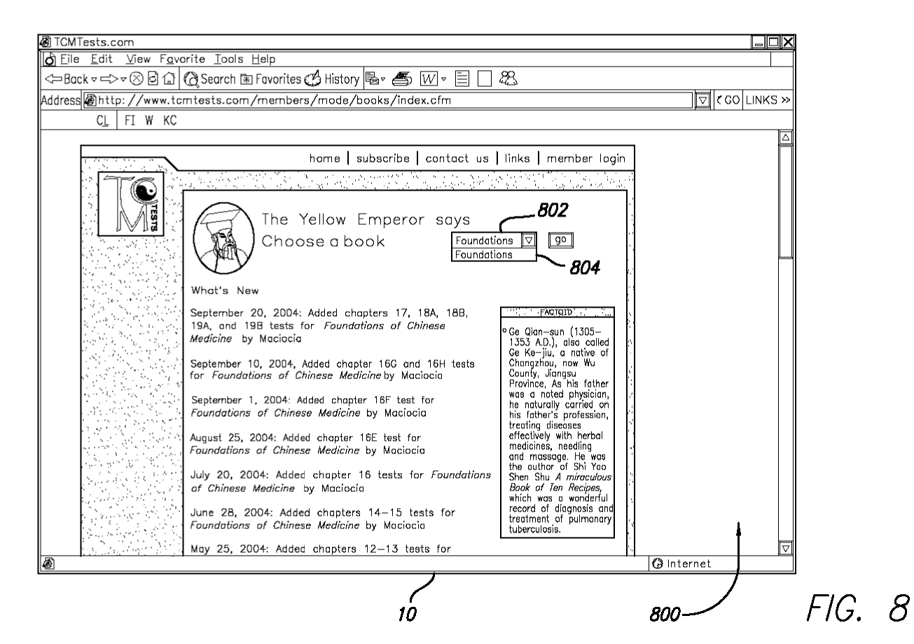

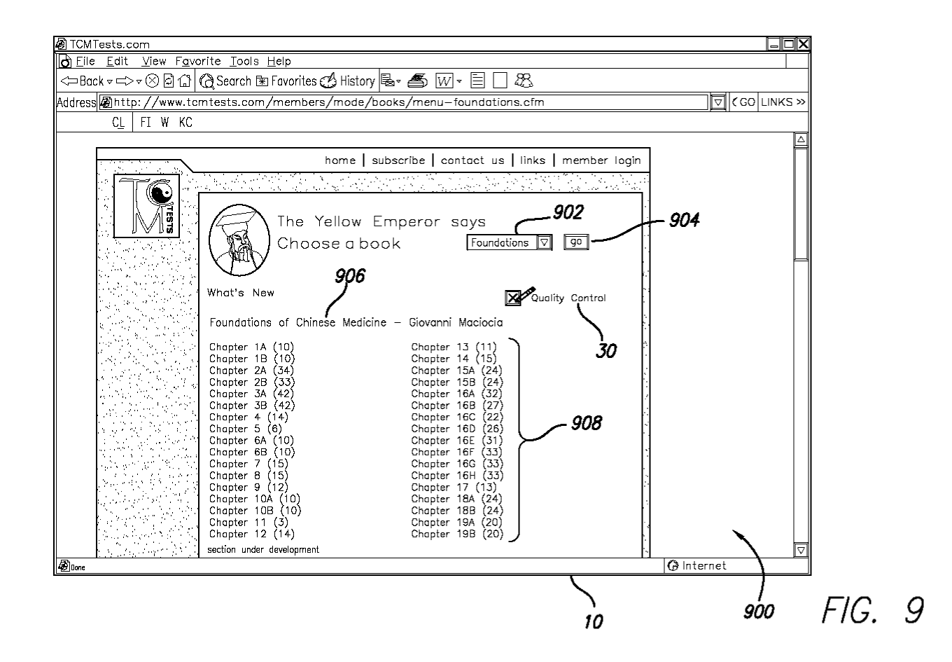

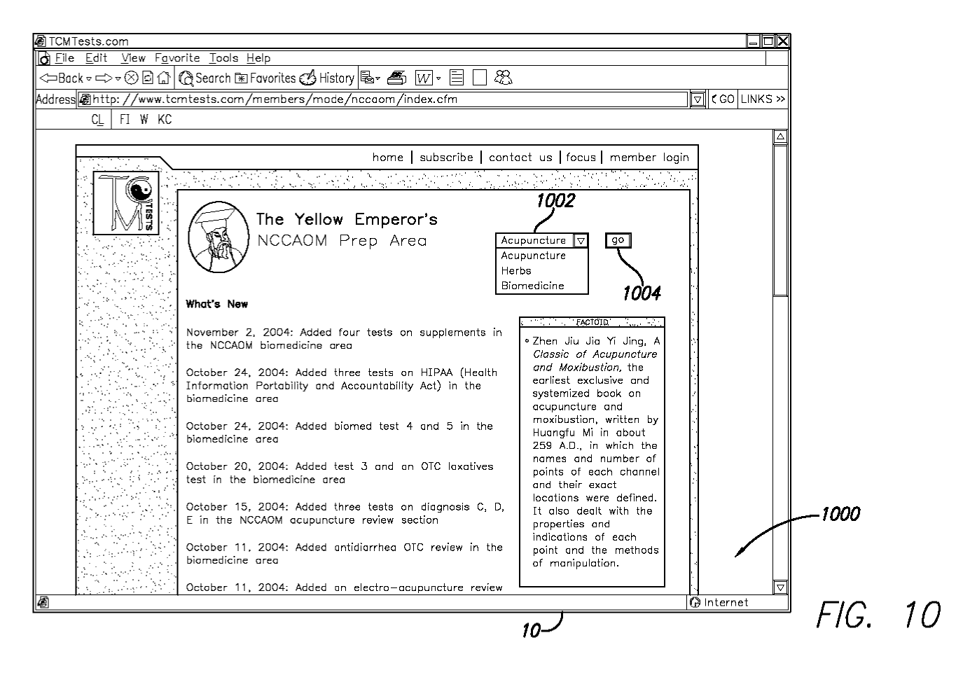

Returning attention to the pull-down menu 402 of FIG. 4, when the user selects the “Books” option from the pull-down menu 402, the web browser 10 displays a book index page 800 as shown in FIG. 8. having a pull-down menu 802 containing a list of book titles and a button 804. The user selects a book title and clicks on button 804. The browser displays a book menu page 900 as shown in FIG. 9. The book menu page 900 lists a book title 906 with a plurality of hyperlinks 908, one for each chapter or section of the book. The user may select an individual chapter from a book by clicking on its hyperlink. When the user clicks on a hyperlink for a particular chapter, a quiz window opens as previously described. System 50 displays questions taken from database module 58 keyed to the selected book and chapter. The user answers the questions and receives feedback as previously described. This embodiment of the present disclosure is particularly useful to users who are in the process of mastering subject matter from a particular book. For example, a student may use this feature of the disclosure to master the subject matter from a given chapter in a textbook. Likewise, an instructor may assign quizzes to test the student's mastery of the subject matter.

In yet another embodiment, the present disclosure may be used to study for certification exams. For example, in the field of TCM, the National Certification Commission for Acupuncture and Oriental Medicine (NCCAOM) is a certifying body for practitioners. The purpose of NCCAOM is to establish, assess, and promote recognized standards of competence and safety in acupuncture and Oriental medicine. NCCAOM requires practitioners who wish to become certified to pass an examination. An embodiment of the present disclosure uses the web-based system 50 to administer quizzes based on the content of certification, accreditation or licensing examinations. These types of examinations are broadly referred to as credential-earnings examination in this disclosure.

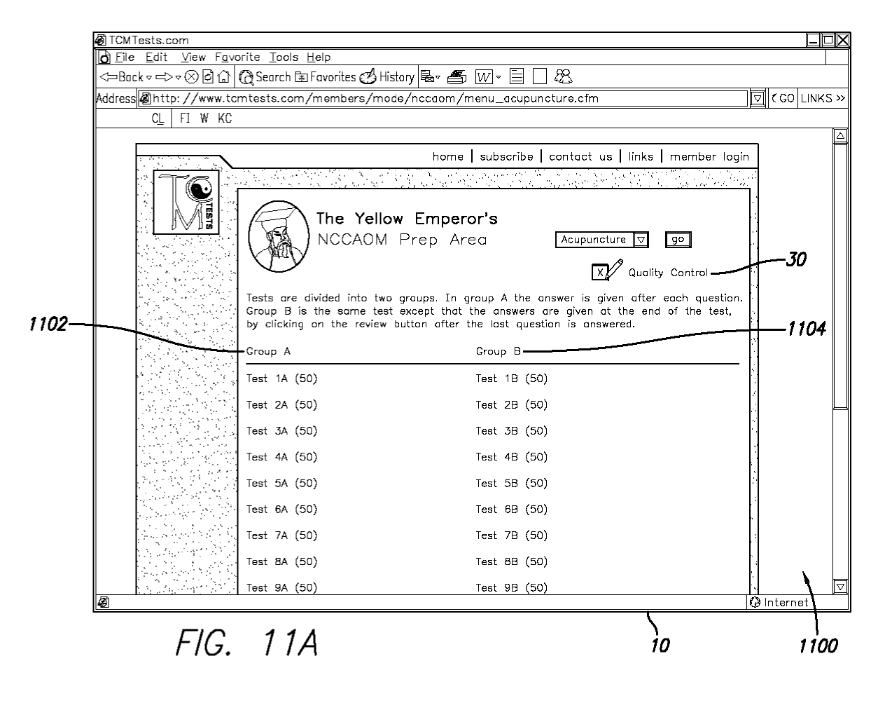

Returning attention to FIG. 4, one of the choices in pull-down menu 402 is NCCAOM. Choosing this link and clicking the button 406 will display the NCCAOM index page 1000 as shown in FIG. 10. The user may select NCCAOM main topics from a pull-down menu 1002 and clicking on button 1004. In the embodiment shown, the NCCAOM main topics are: Acupuncture, Herbs, and Biomedicine.

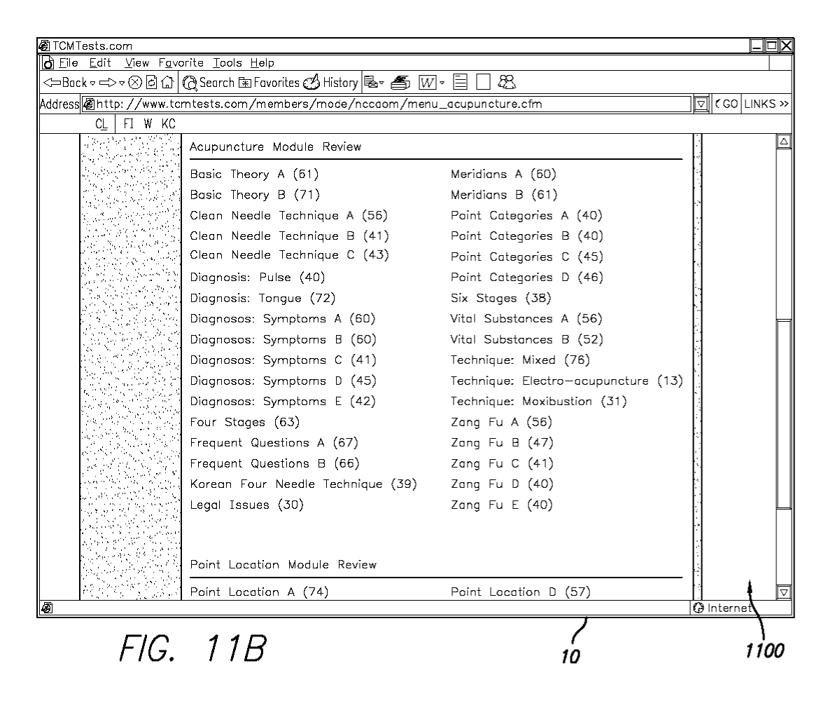

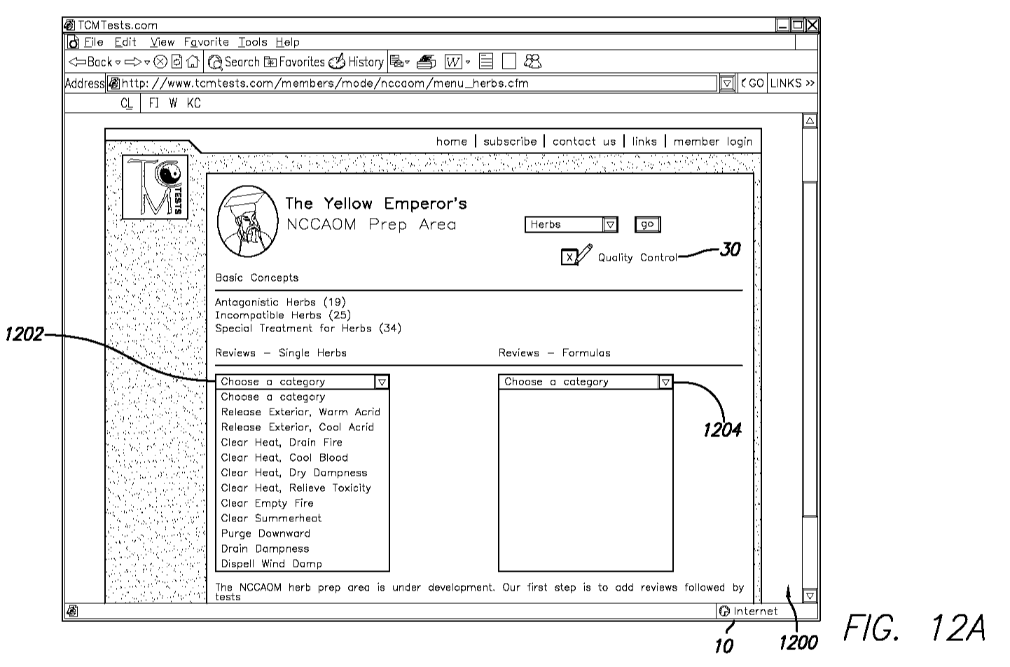

By selecting Acupuncture from pull-down menu 1002, the browser displays the acupuncture menu page 1100, FIGS. 11A and 11B. From the acupuncture menu page, the user may select a particular quiz by clicking on the desired hyperlink. In the embodiment shown in FIG. 11A, the user may select from “Group A” tests 1102 and “Group B” tests 1104. The information contained in the corresponding numbered test is the same in both Group A and Group B, however tests in Group A provide feedback after each question is answered by the user while tests in Group B provide feedback only after all questions in the test have been answered. Thus Group B approximates a test given under examination conditions. Also, Group B-type tests may be used to administer examinations for academic credit or accreditation.

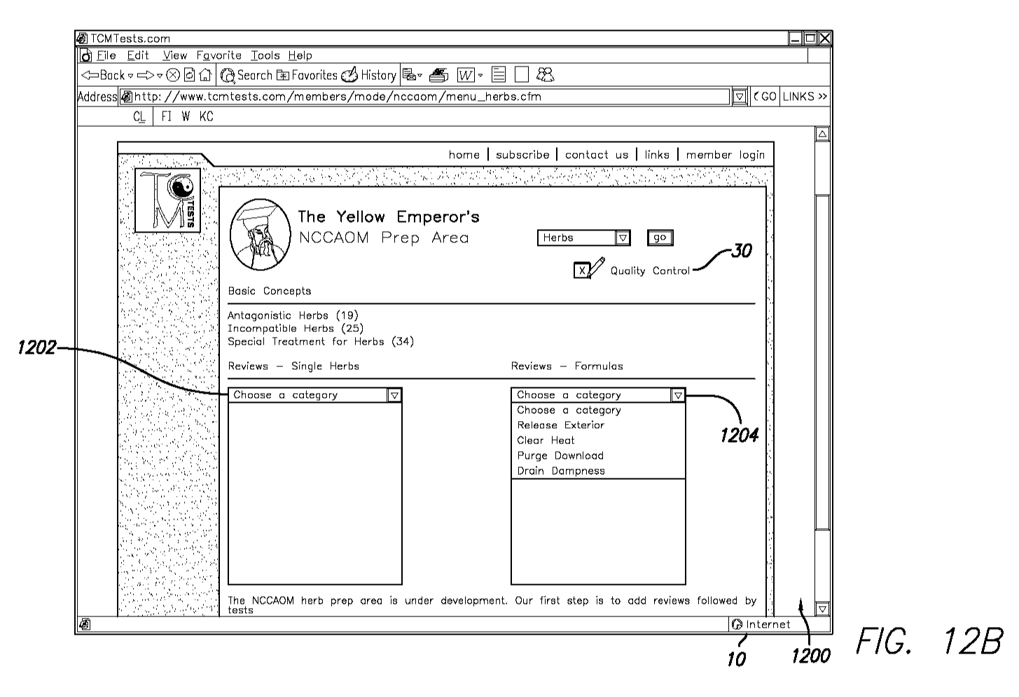

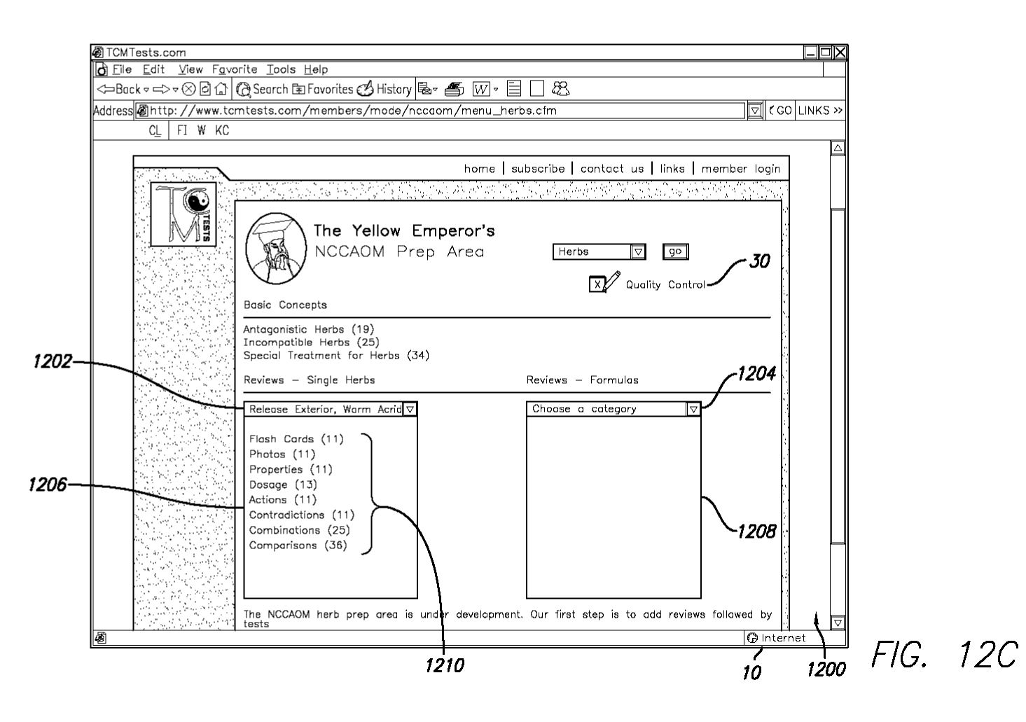

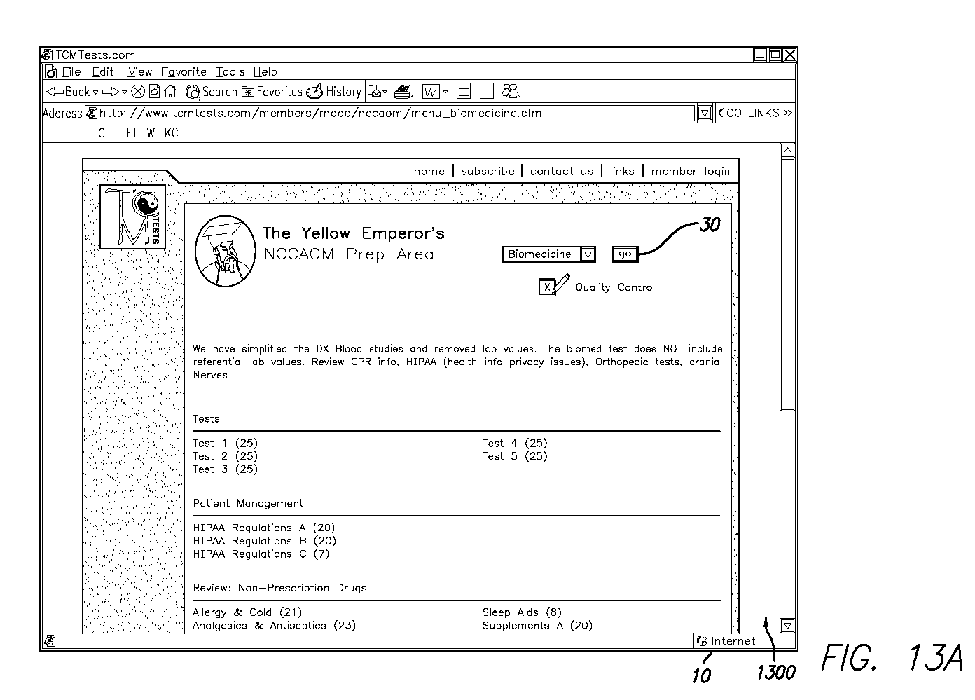

FIGS. 12A-12C depict an embodiment of an NCCAOM herbs menu page 1200. The herbs menu page 1200 allows the user to select quizzes by clicking on hyperlinks as already described. This embodiment also has a single herb review pull-down menu 1202 and a formula review pull-down menu 1204. Pull-down menus 1202 and 1204 each contain links to a number of categories for the user to choose from. When the user chooses a category, hyperlinks 1210 for quizzes within the chosen category appear in an area 1206, 1208 proximate to the pull-down menus 1202, 1204 as shown in FIG. 12C. The user may then click on one of the hyperlinks wherein a quiz is administered as previously described.

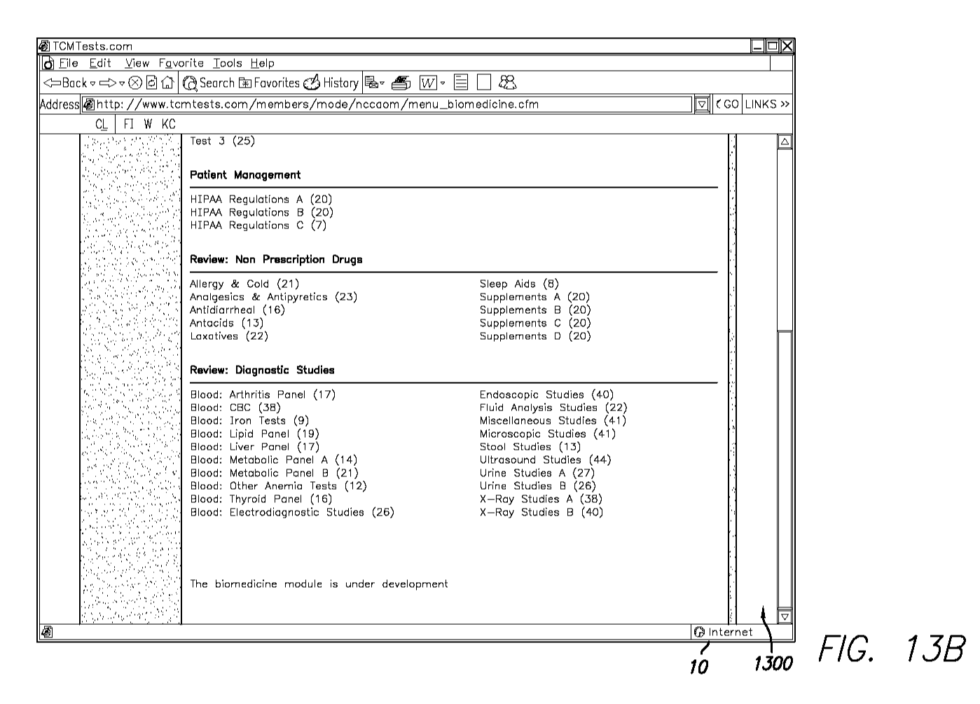

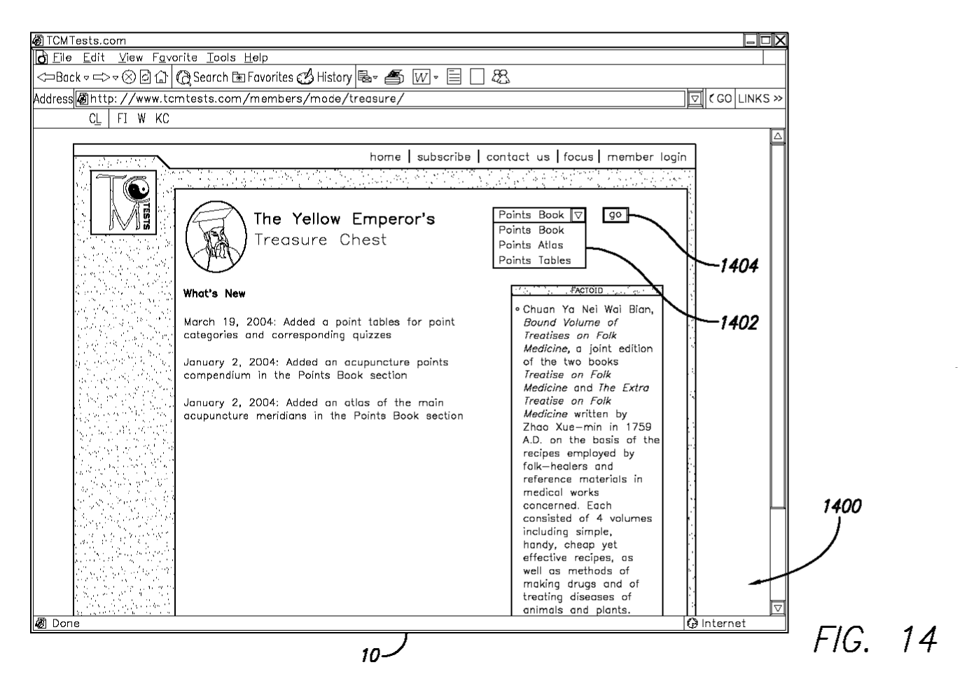

FIGS. 13A and 13B show an embodiment of a biomedicine menu page 1300. Subject matter on the biomedicine page 1300 generally relates to the intersection of TCM with modern Western medicine. For example, subject matter may include anatomy and physiology, pharmacology, diagnostic techniques, and health-care law. The user is able to select quizzes on biomedicine by clicking on hyperlinks. System 50 then administers biomedicine quizzes in the manner previously described.

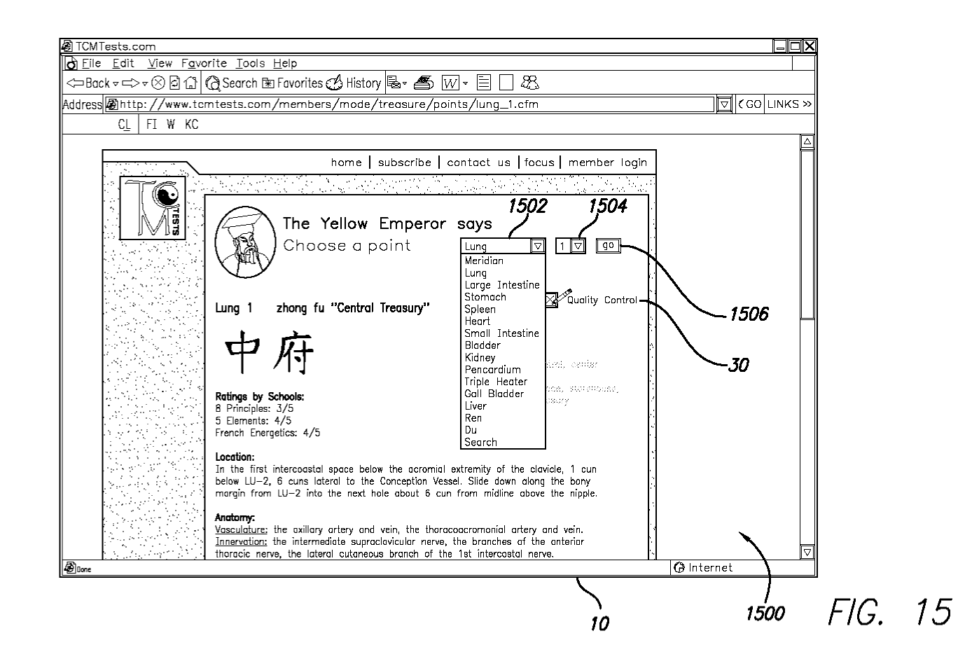

Referring once again to the pull-down menu 402, in FIG. 4, there is a link for “Treasure Chest.” The Treasure Chest generally describes access to content devoted to reference and educational information as well as other information of interest and value to a student or practitioner of TCM. If a user selects the Treasure Chest option from pull-down menu 402 and clicks on button 406, the browser 10 will display the Treasure Chest page 1400 shown in FIG. 14. The Treasure Chest page has a pull-down menu 1402 containing a list of various reference materials. The user selects one of the references in the list and clicks on button 1404 to display the information.

In the embodiment shown in FIG. 14, the menu choices for the Treasure Chest pull-down menu are: Points Book, Points Atlas, and Points Tables. As should be apparent, other menu choices are possible depending on field of study.

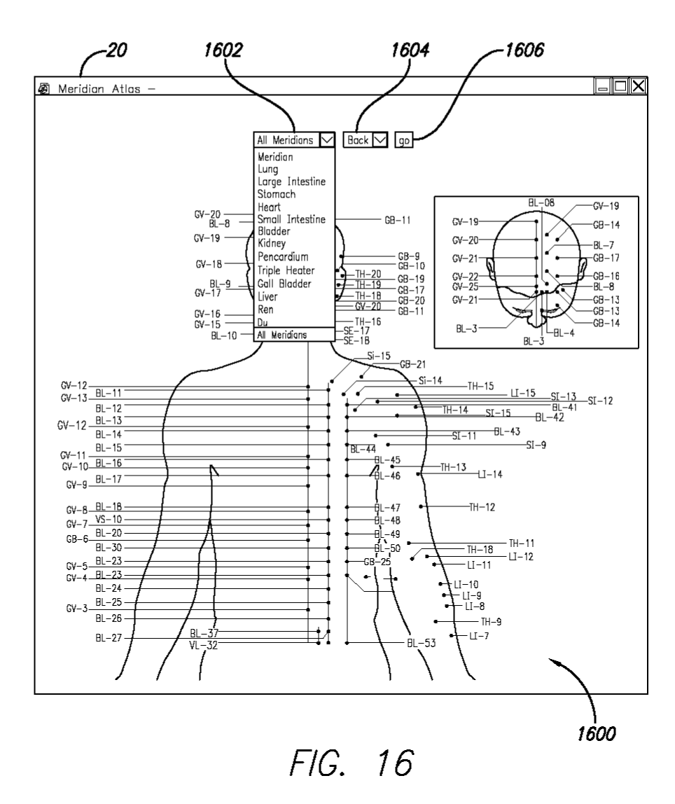

If a user selects the “Points Book” menu choice from pull-down menu 1402 and clicks button 1404, the browser displays a points book menu page 1500 as illustrated in FIG. 15. The user selects a particular acupuncture point by its location from the choices in pull-down menu 1502. The user then selects the particular number of the point of interest from pull-down menu 1504. The user clicks on button 1506 to display a web page containing data for the chosen acupuncture point. As an illustrative example, FIG. 15 is displaying the point data web page containing information for the point “Lung 1.” The point data page contains information such as the point name, the Chinese characters for the point, the location, anatomical data, attributes, synergistic points, indications, spirit of point, classical functions, and effects.

If a user selects “Points Atlas” menu choice from pull-down menu 1402 and clicks button 1404, a new browser window 20, as shown in FIG. 16, is superimposed over the open browser window 10 (not shown). Although one embodiment of the present disclosure opens a new Points Atlas browser window, an equally acceptable embodiment displays the Points Atlas in the existing browser window. The Points Atlas is a map of acupuncture points on the human body. The Points Atlas page 1600 has a pull-down menu 1602 that displays point areas. The user may select points for specific meridians or points for all meridians. Once the user selects the points to be displayed, the user selects a choice from pull-down menu 1604 indicating a front, back or side view of the body. When the user clicks button 1606, an image is displayed in the Points Atlas window showing the location of the acupuncture points on the body. The user may change the view of the points or the body by selecting different choices in pull-down menus 1602, 1604 and clicking button 1606 or by holding a mouse pointer over a particular point and clicking on it. The Points Atlas page 1600 illustrated in FIG. 16 depicts the acupuncture points for all median on the back of the body.

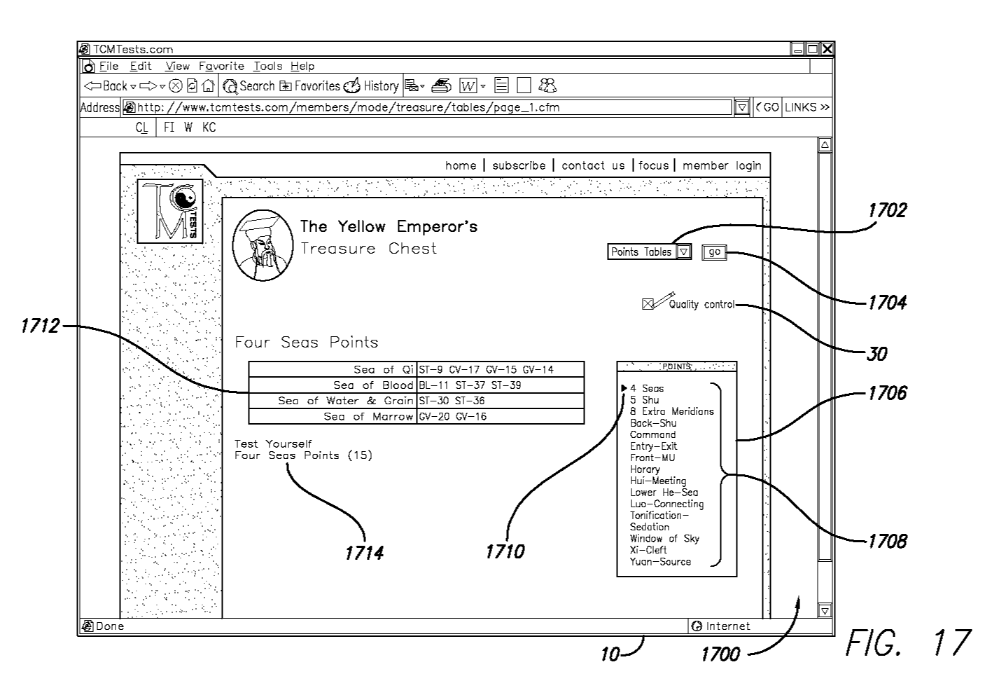

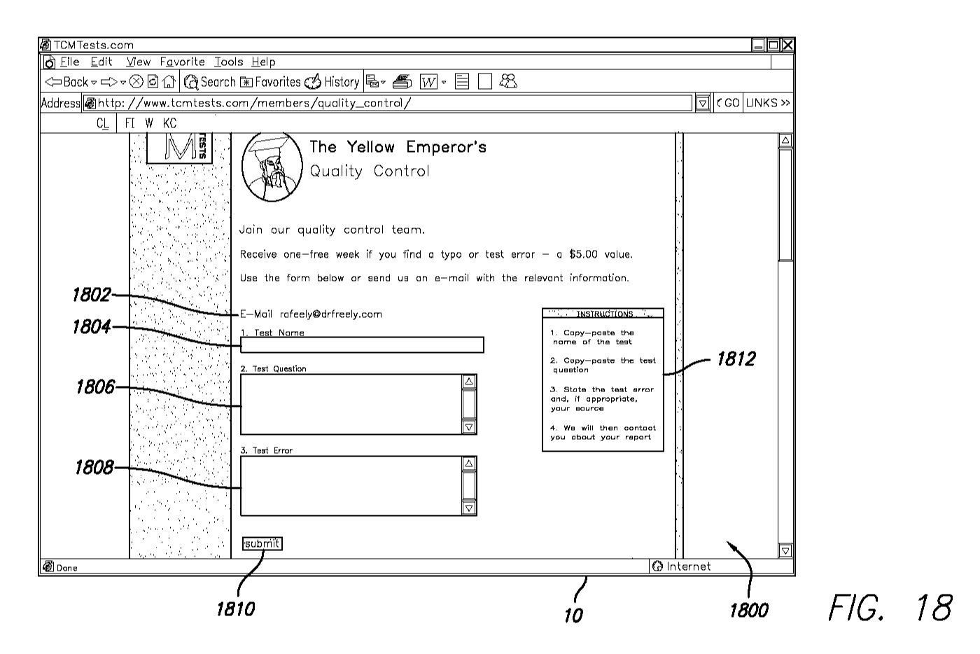

If a user selects the “Points Tables” menu choice from pull-down menu 1402 and clicks button 1404, the browser displays a points tables page 1700 as illustrated in FIG. 17. The user is able to select a particular point table to view by clicking on one of the plurality of hyperlinks 1708 contained in a points menu 1706. An indicator 1710 appears next to the hyperlink in menu 1706 for the points table displayed. A points table 1712 is displayed containing the point names and the point numbers. Additionally the user may take a quiz on the points by clicking on a hyperlink 1714.

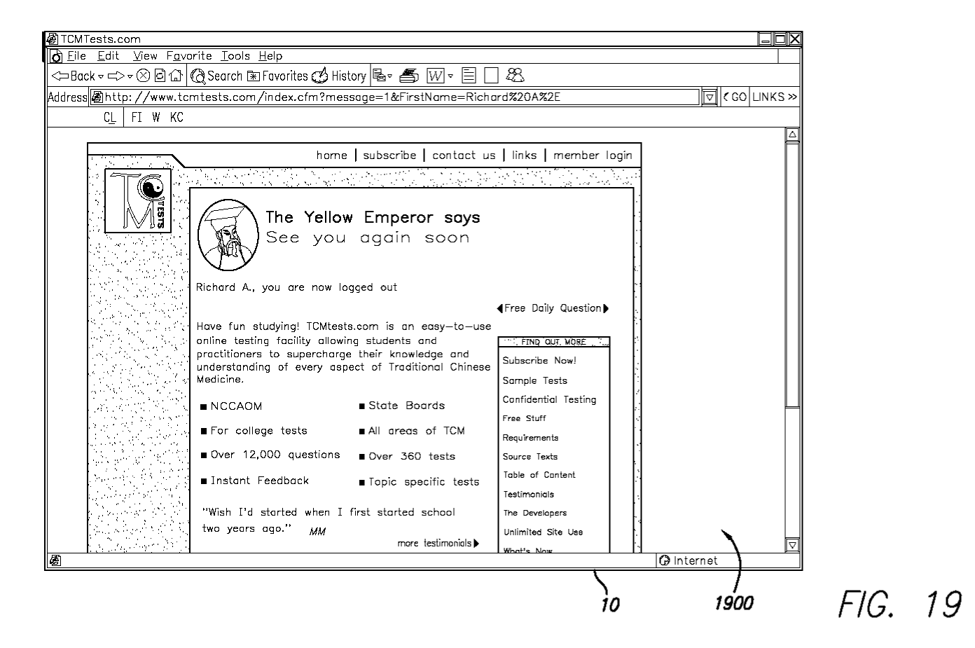

Referring again to the illustrated embodiment of FIG. 17, a quality control hyperlink 30 provides the user a way to provide feedback to the operators of system 50. The quality control hyperlink 30 may appear on any of web pages of the present disclosure as illustrated by FIGS. 6A, 9, 11A, 12A-C, 13A, 15, and 17. When the user clicks on the quality control hyperlink 30, a quality control page 1800 opens in the browser window 10. The quality control page 1800 displays the user's email address 1802 and provides text boxes 1804, 1806, 1808 for the user to identify the test name in which the error occurs, the test question, and a description of the error. The user then clicks the submit button 1810 to notify the operator of the website of any errors. After the system operator reviews the report, the system operator may contact the user to provide an update or to inform the user of a resolution. The embodiment of FIG. 18 also contains instructions for the user to follow in submitting the error report. Additionally, the system operator may offer incentives for users to report errors such as free subscription time, free merchandise, discounts, gift certificates, reward points or some other form of goods and services.

When the user has finished a session using the system 50, the user may click on a member logout link 422 on the navigation menu 408. When the user clicks the member logout link, logout page 1900 is displayed in the browser window 10 as shown in FIG. 19. The logout page 1900 displays the user's name along with confirmation that the user is logged out. Additionally, system 50 may automatically logout a user after a given period of inactivity.

The system 50 described herein, may incorporate features that prevent a user from downloading contained within. For example, such features may include a software module, code, script, etc. which prevent the user from printing, screen printing, copying, viewing the source code, or otherwise transferring data either electronically or otherwise off of the system 50 via a browser.

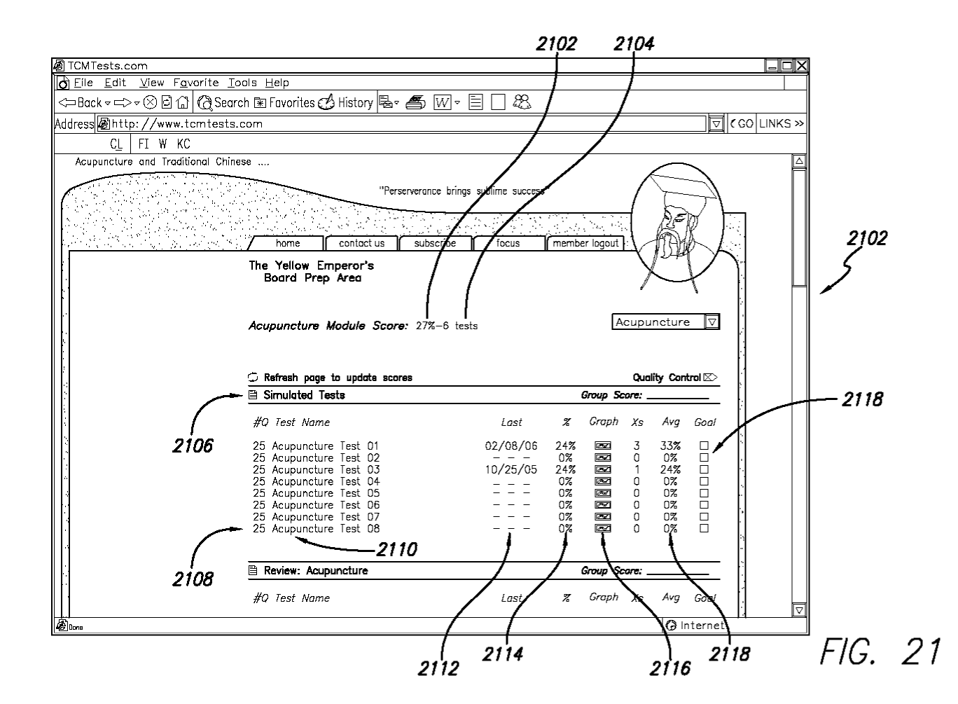

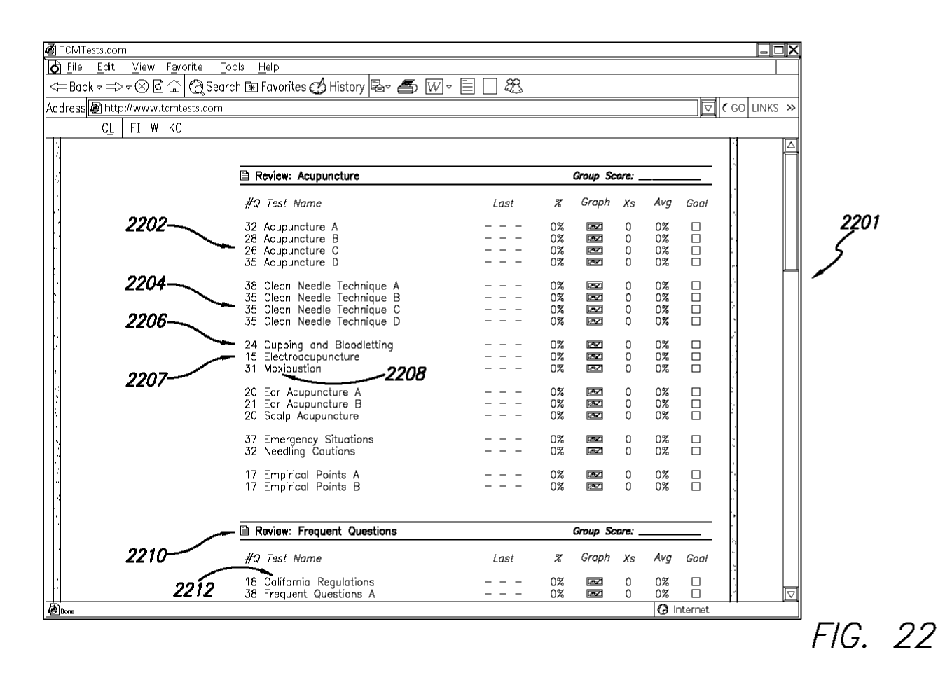

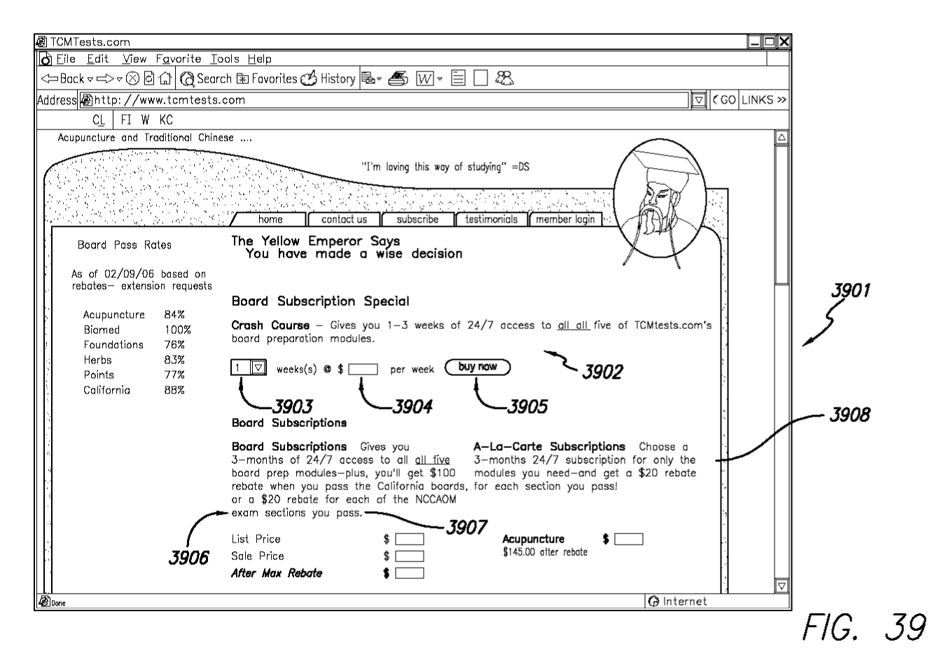

Additional exemplary embodiments and features are shown in FIGS. 21-44. FIG. 21 shows an acupuncture page 2102 where statistics about past tests are displayed to assist the user in his or her studies. Statistics may include, but are not limited to an average test score 2102 and the number of tests taken 2104. Each relevant category of test batteries may be identified such as simulated test section 2106 listing each test, the number of questions in each test 2108, an identification for each test 2110, a date the test was taken 2112, a percentage of questions answered correctly 2114, and an average score over a plurality of times a test is taken 2118. A link to a corresponding graph to graphically show test results may also be provided 2116. A check box 2118 may also be shown to automatically display when a user has scored a passing score or the user checks the box when the user believes the score is otherwise sufficient. FIGS. 22-25 are a continuation of FIG. 21, displayed in this example, when a user scrolls vertically down a web page embodiment. Portion 2201 shows additional categories of tests and subtests including acupuncture tests 2202, clean needle technique tests 2204, cupping and bloodletting test 2206, electroacupunture test 2207, and moxibustion test 2208. Another category of questions is shown as frequent questions section 2210 which may include state regulations, such as frequent questions from California regulations 2212.

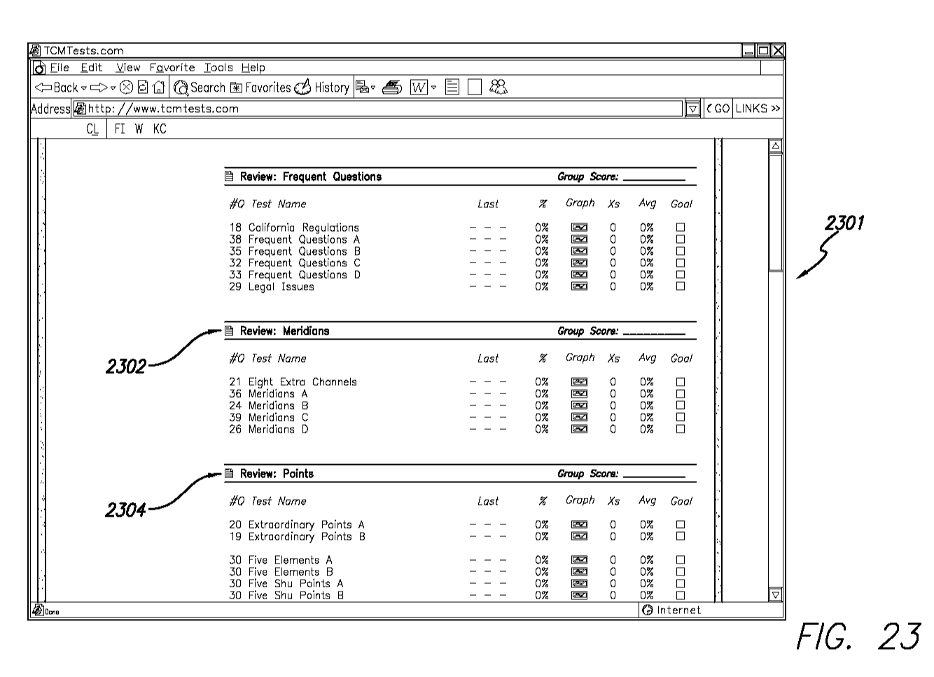

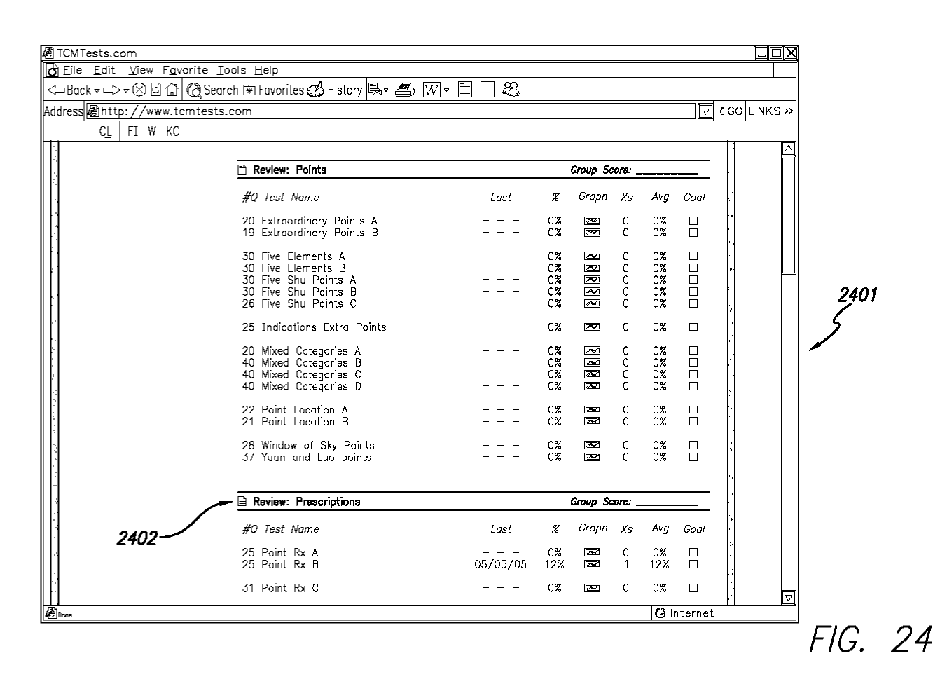

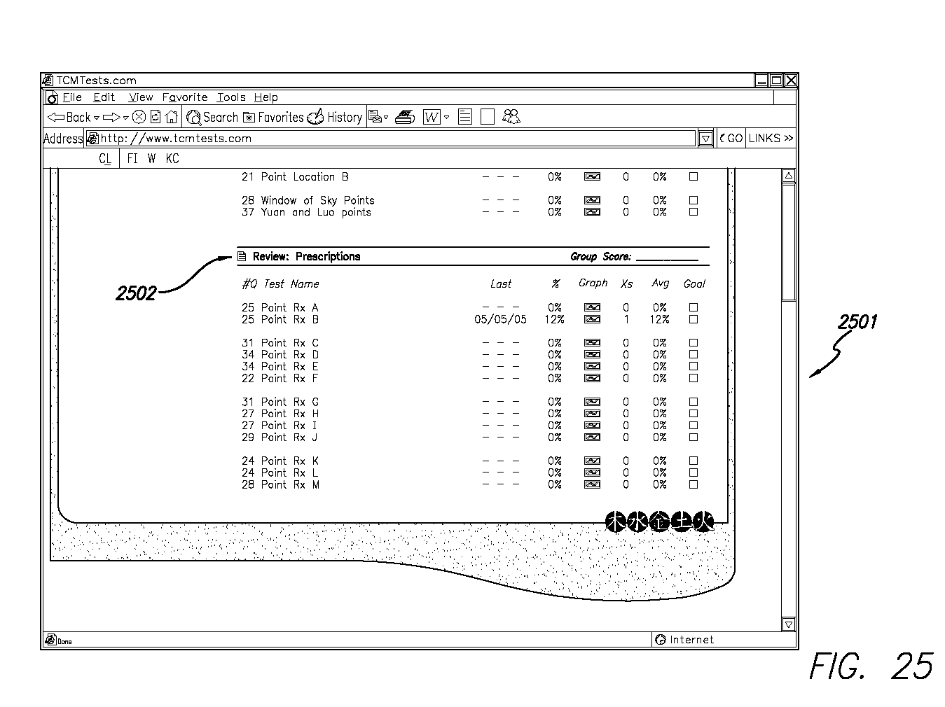

FIG. 23 shows another portion 2301 and additional sections on meridians 2302 and points 2304. FIG. 24 shows another portion 2401 with a review section on prescriptions 2402, shown in additional detail in section 2502 of portion 2501 of FIG. 25.

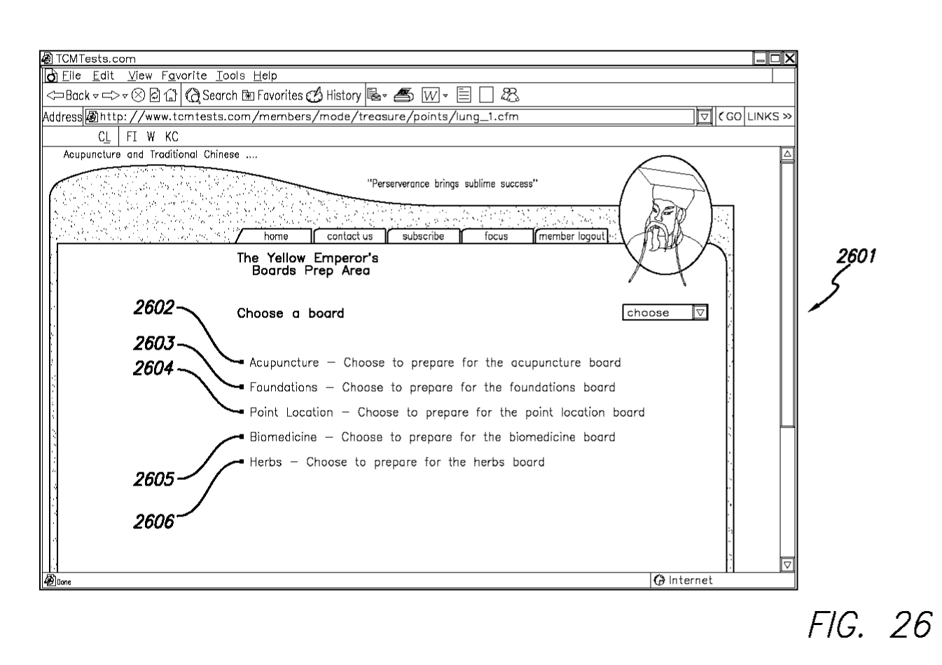

FIG. 26 shows a selection web page 2601 that allows a user to select a particular board and thus load a selection of quizzes, tests, and other study material related to the selected board. The boards include, but are not limited to, acupuncture 2602, foundations 2603, point location 2604, biomedicine, 2605, and herbs 2606.

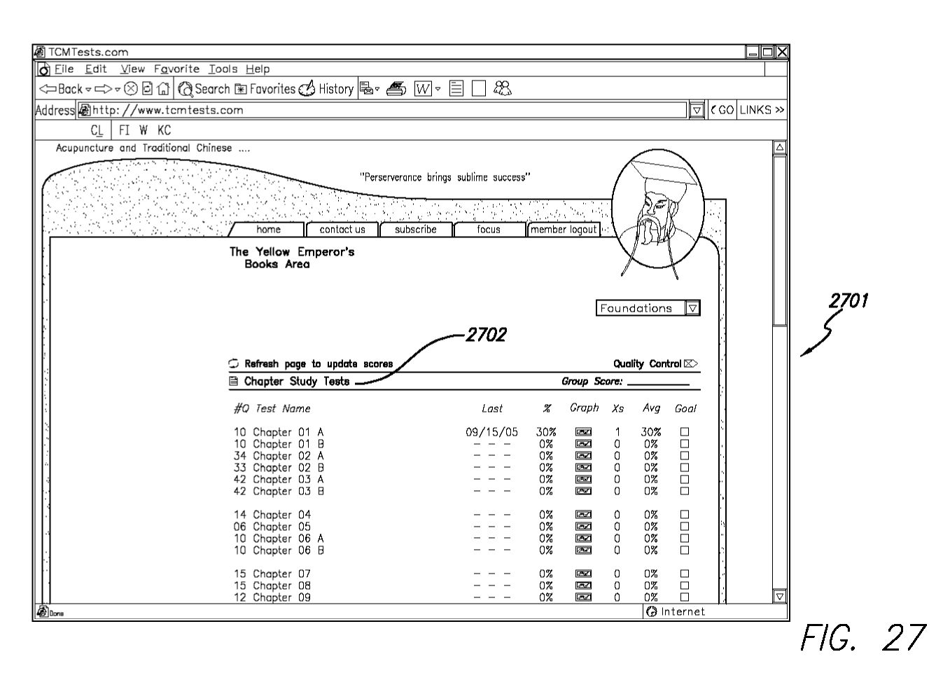

FIG. 27 shows a study page web page 2701 that similarly lays out test questions keyed to particular chapters of a selected text book for a particular board. Chapter study questions section 2702 may include batteries of questions divided by chapter, or dividing a chapter into multiple parts, depending on the number of questions desired to be presented. Seminal books on a particular board or subject may be a good source of information and having study materials closely tied to such book can increase the chances a board examination is passed.

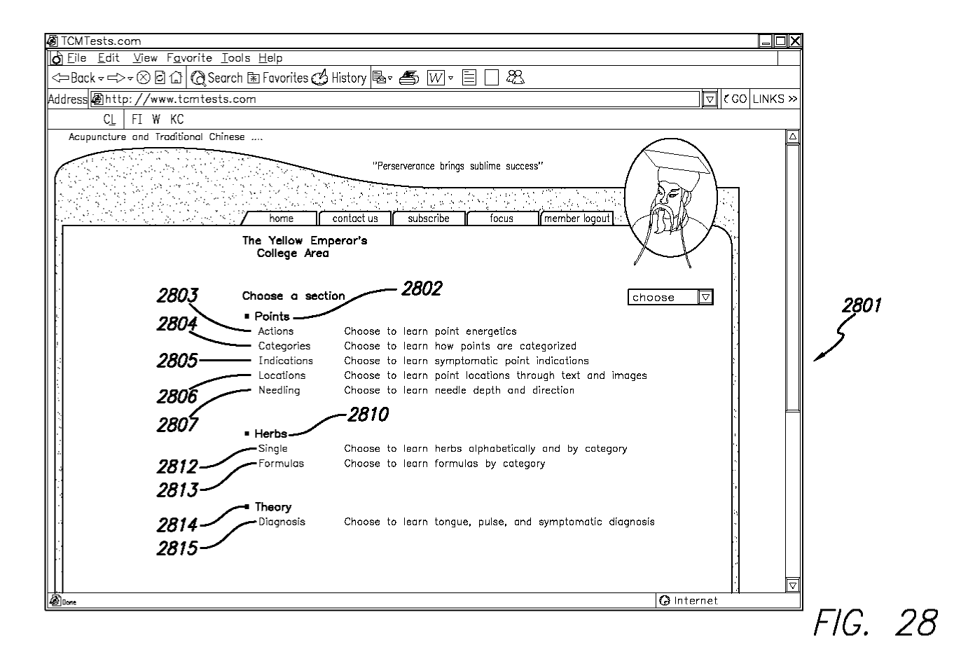

FIG. 28 is yet another web page 2801 showing a division or category of tests, quizzes, and/or learning materials, referred to here as a college area. Sections of this page include points 2802, herbs 2810, and theory 2814. Subsections for points include actions 2803, categories 2804, indications 2805, locations 2806, and needling 2807. Herbs 2810 include single herbs 2812 which may be learned alphabetically and by category or formulas 2813. Theory 2814 may include a diagnosis section 2815 and other sections related to theory. Although these areas, categories, and subcategories are shown, others ways to organize the study information may be used as well.

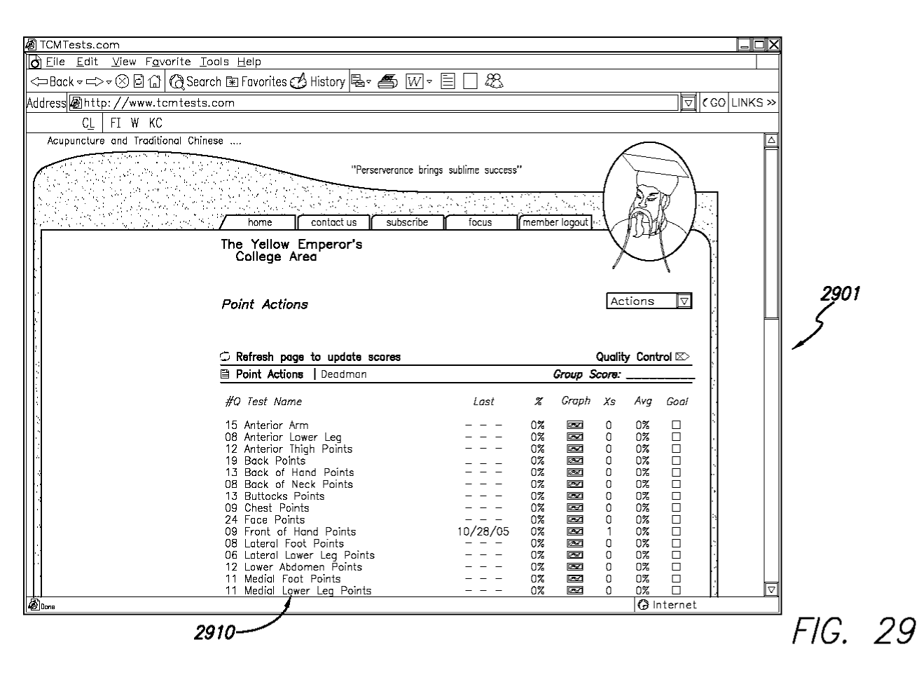

FIG. 29 shows an illustrative embodiment 2901 of a points bank of tests 2910. This bank may include one or more of the following tests: anterior arm, anterior lower leg, anterior thigh points, back points, back of neck points, buttocks points, chest points, face points, front of hand points, lateral foot points, lateral lower leg points, lower abdomen points, medial foot points, and medial lower leg points. Other tests may be included as well.

The present user interface for test preparation and education may be provided using a variety of business methods including but not limited to a subscription service, a fee for each credential-earning examination being studied, a university wide fee, a group of users fee, or any combination thereof. Subscription fees can be for any period including yearly, monthly, weekly, daily, quarterly, or over some other period. The duration may be for a set period, or be set off prior to a particular exam, for example, the subscription may be offered beginning four months prior to a board examination. Group subscription may include more than one individual, a class, a school, a university, and country-wide subscription, a government subscription, and others.

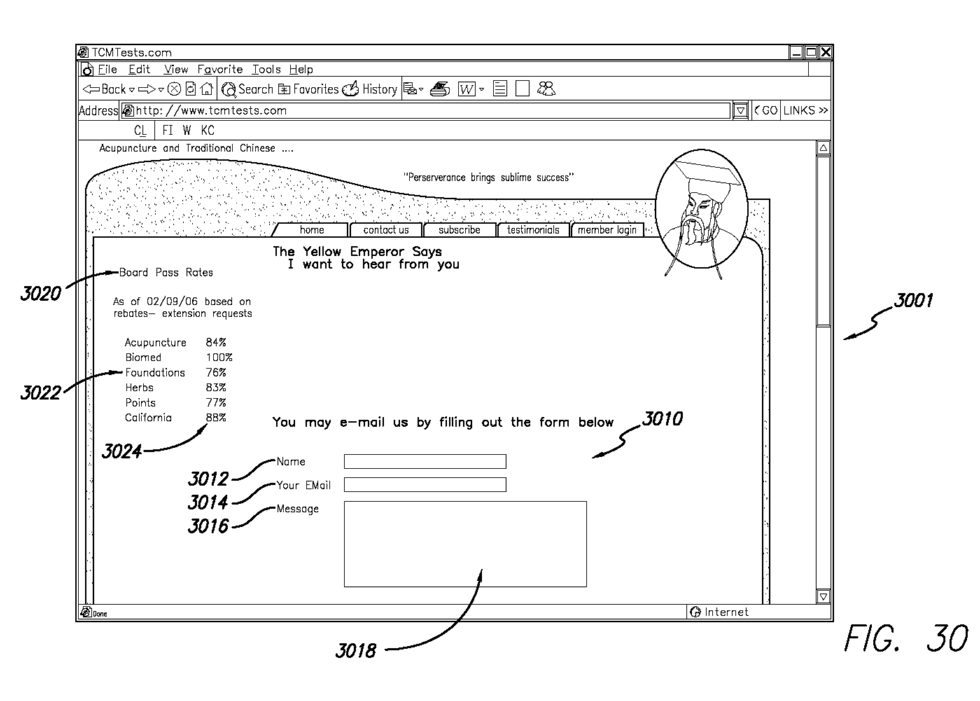

FIG. 30 is an embodiment of a feedback page 3001 where users and/or visitors can enter their information 3010 including their name 3012, email 3014, and a message 3016 to provide information to the site administrators. FIG. 30 also shows success information for users of the site 3020. This information is shown here as an example, the success percentages of section 3020 may be displayed on any of the web pages discussed herein. Pass rates may be collected by survey from subscribers or directly from testing services that collect study program information. Subscribers participating in a results survey of this type may be rewarded with some value, including but limited to a rebate, coupon, cash, credit for future exam preparation, or discount on other study materials. Passage statistics may identify a particular board 3022 such as the acupuncture, biomed, foundations, herbs, points, and California boards, or show some other metric. Passage rates 3024 may be displayed alongside each board.

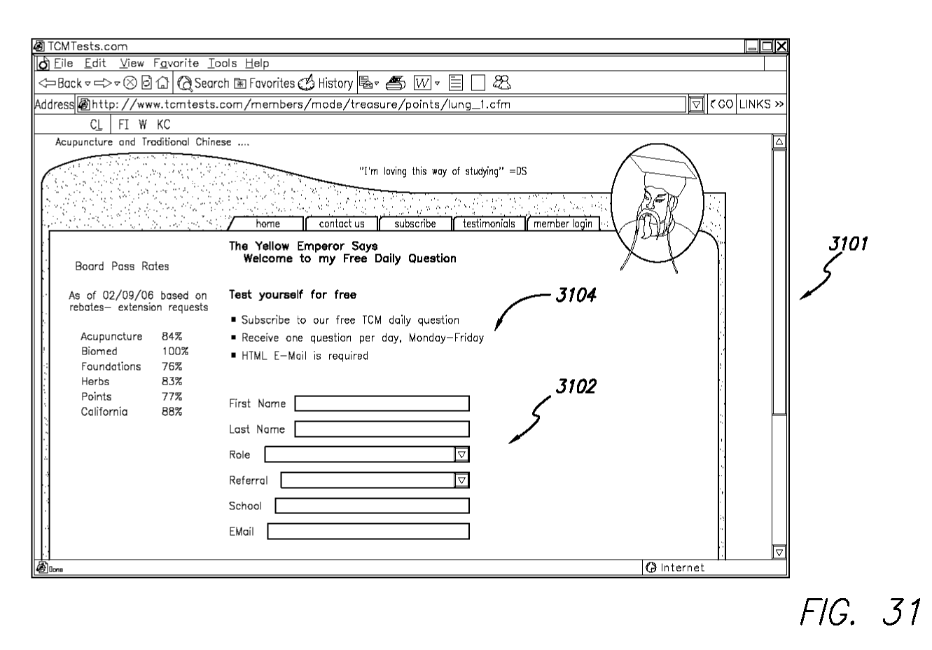

The present system, method, and computer program product may also allow visitors to subscribe to free questions using interface 3101. The free question may be emailed or otherwise delivered over a particular period, such as daily Monday-Friday as shown in the text in FIG. 31 (see 3104). In exchange, a visitor enters their contact information, which may be used for further offers to that visitor.

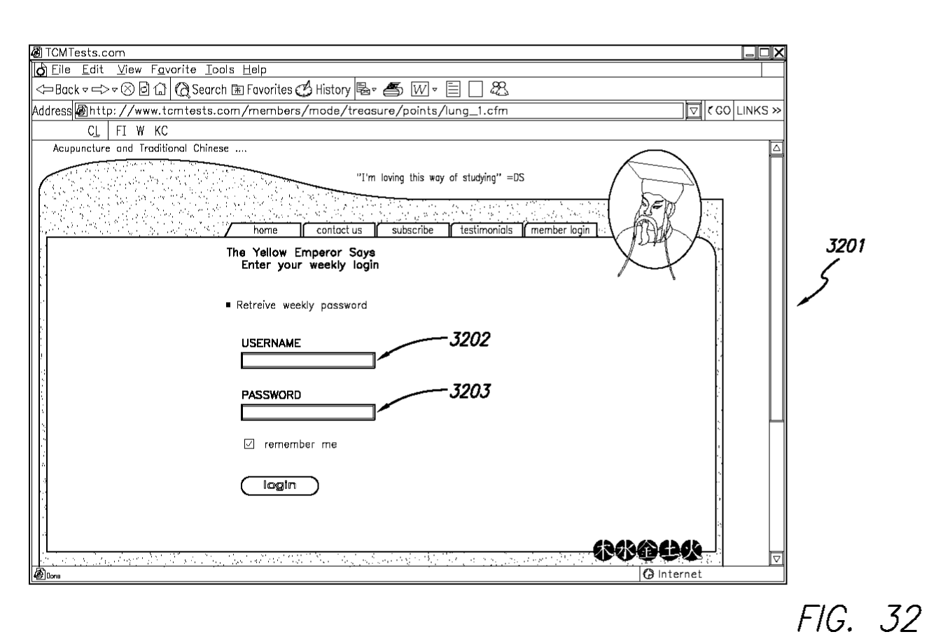

In a subscription environment, users access is restricted, such as by a username and password shown in the login interface 3201 of FIG. 32. It is also contemplated that the services may be provided at no charge to users, with revenue instead coming from related advertisements displayed on the site or in affiliated emails.

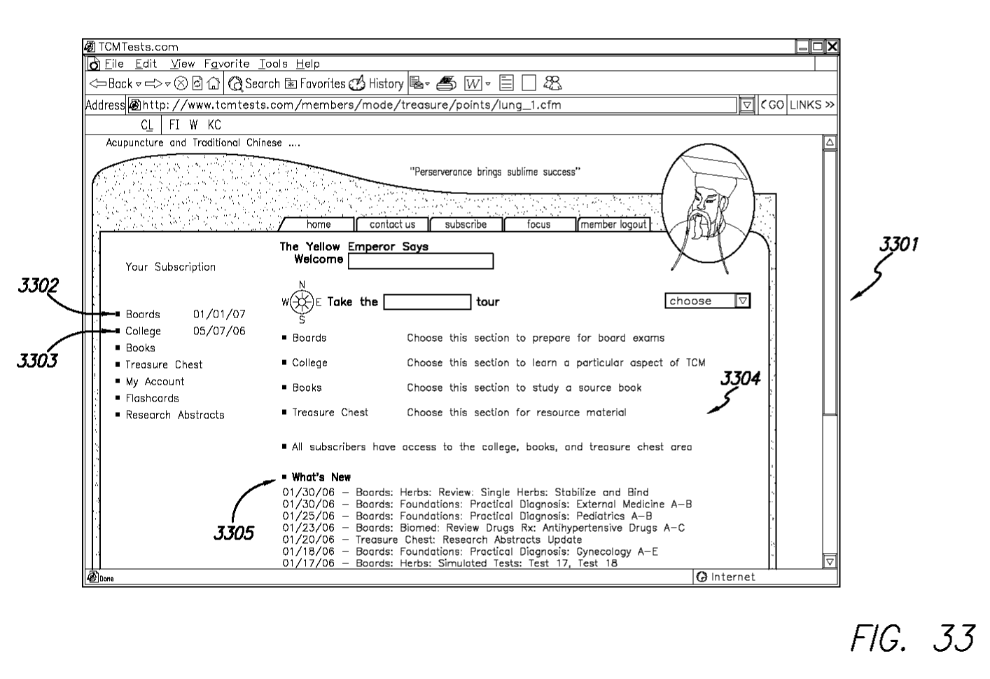

FIG. 33 shows an additional navigation interface 3301 that is divided into sections 3304, here including boards, college, books, and treasure chest. Navigation interface 3301 may also include upcoming board examination dates such as upcoming dates for board 3302 and college 3303 examinations. A what's new section 3305 may also display information about the current state of the site including added, removed, or modified sections, and additional resources.

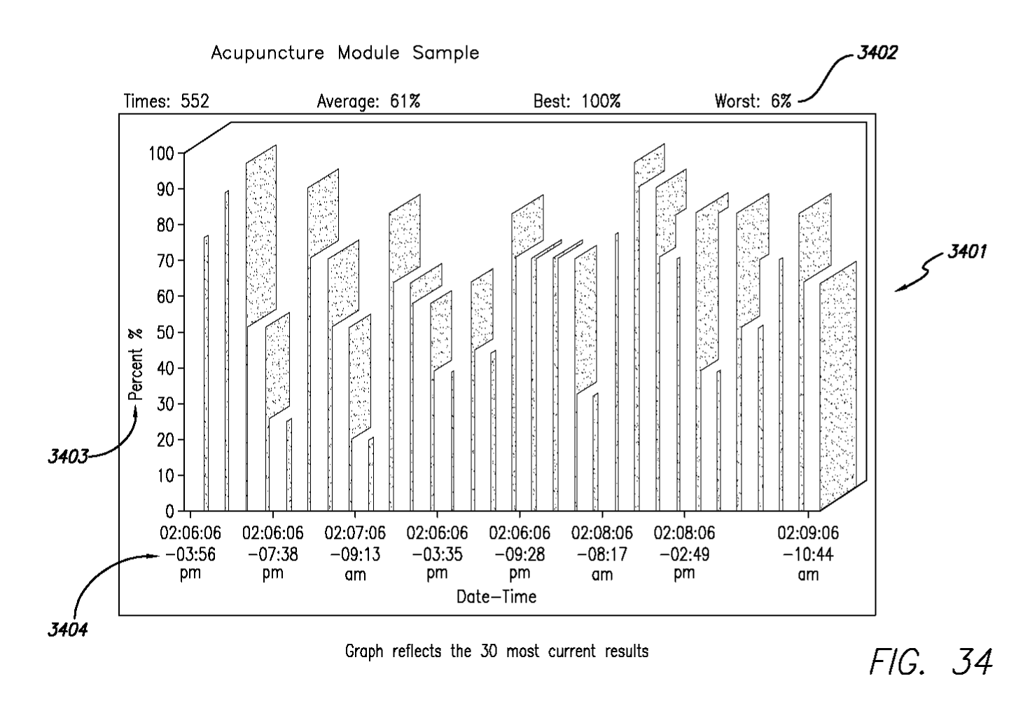

FIG. 34 is a sample graph showing results across tests, quizzes, or other banks of practice questions. Graph 3401 includes a percentage correct y-axis 3403 and an identification along the x-axis 3404 when the particular bank of practice questions was taken. This identification may include date and time information. In the example shown in FIG. 34, the results are graphed as stack bar charts. Other graphical formats may be used as well. Additional statistical information across the tests may also be displayed 3402, including the times (which may includes the number of times a test was taken), and average, best and worst scores.

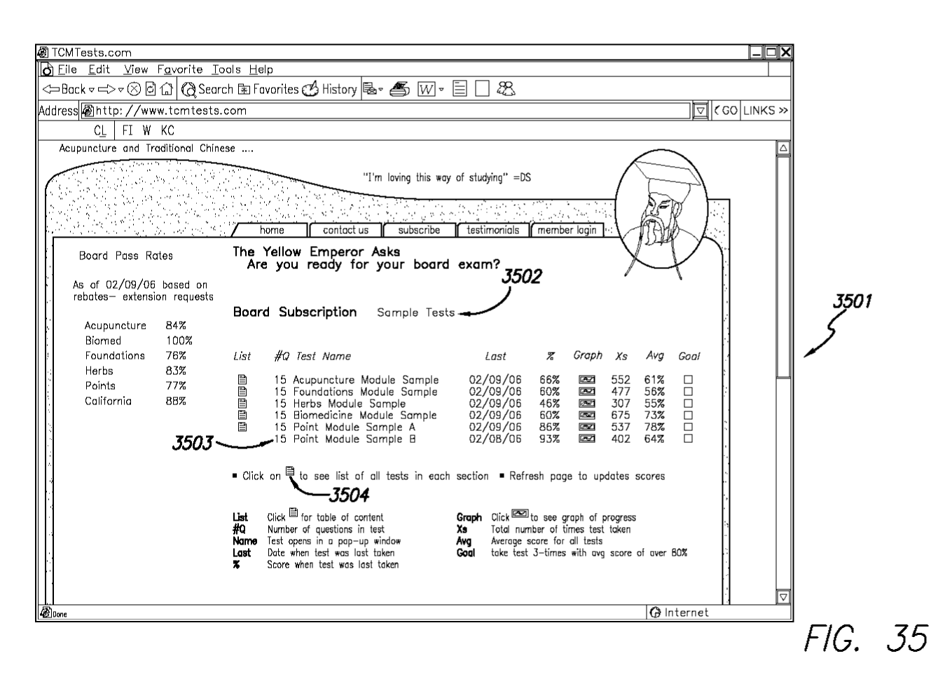

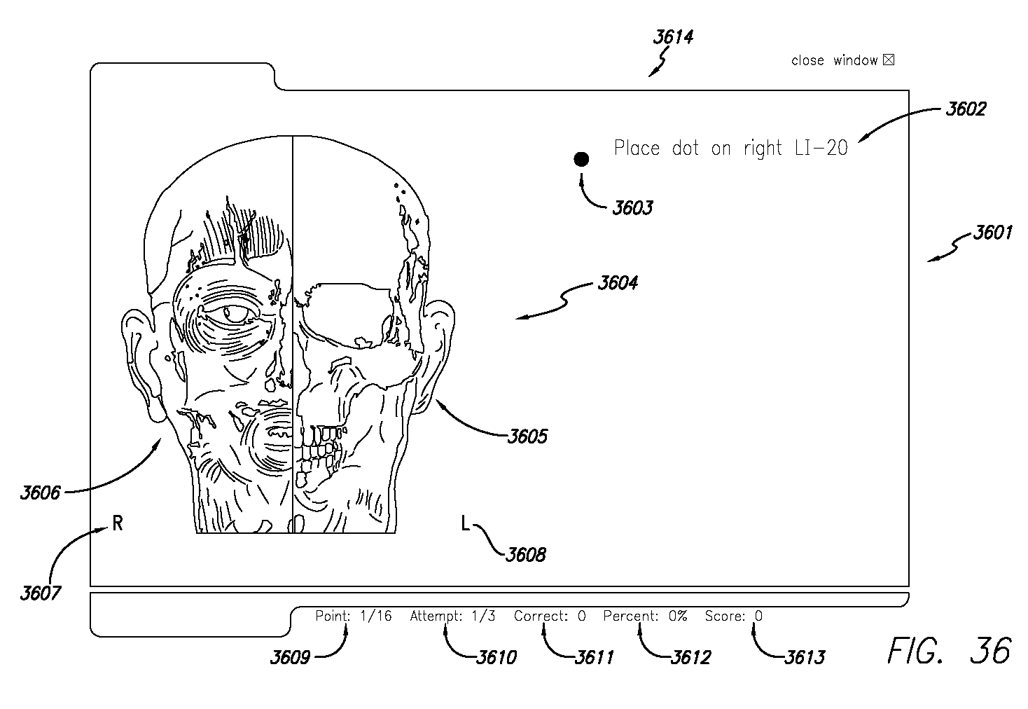

FIG. 35 is an embodiment 3501 of a boards subscription test that lists sample board question modules. Tests may include selected old or published exam questions, or questions based on old or published questions, or other questions useful for board review. The sample tests displayed in a similar columnar format as described above for other question banks. Additional tests may be displayed by clicking on a link 3504.

FIG. 36 is an example 3601 of a test question that also includes an anatomical illustration. The test question or prompt 3602 in this example asks the user to place a dot on right LI-20 on the illustration 3604. Illustration 3604 may be divided into a left section 3605 and a right section 3606 which may be illustrated differently, such as a bone structure illustration and a muscle structure illustration as shown. A left side indicator 3608 and right side indicator 3607 may be displayed to provide the user with the proper orientation since the illustration is facing the user, and thus left and right is reversed. The user can place the dot using his or her mouse by dragging the dot to the selected location on the illustration 3604.

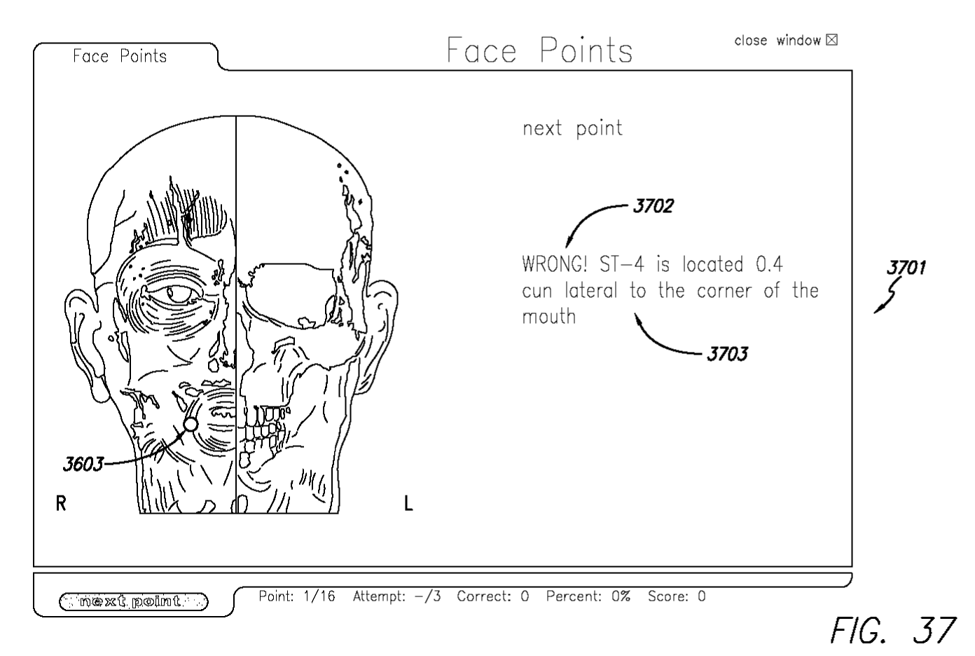

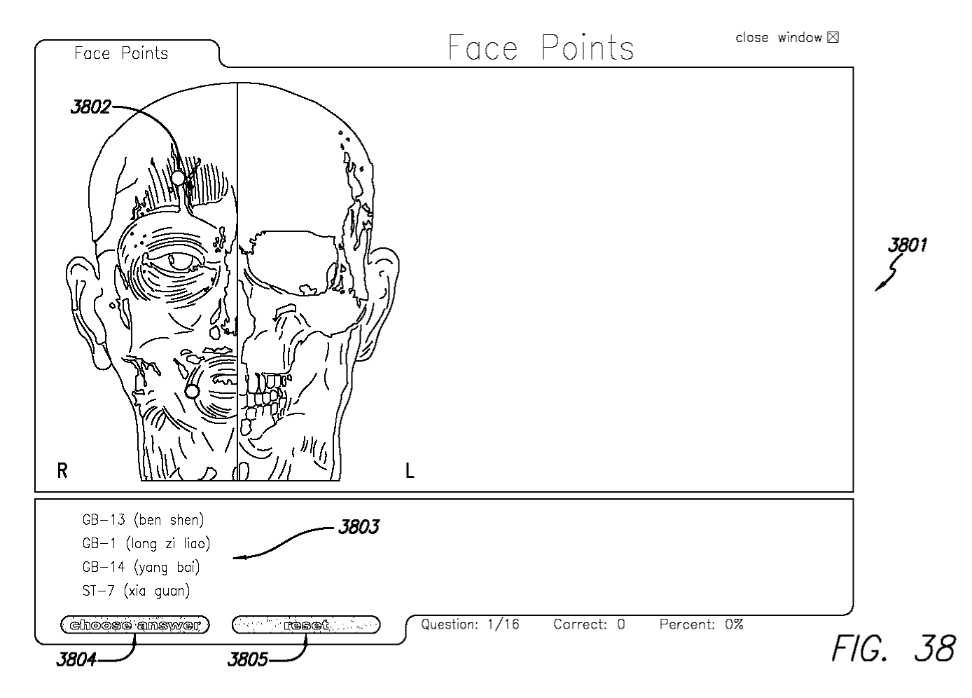

FIG. 37 is an example screen 3701 showing the result of a user position dot 3603 on an incorrect location. A message 3702 is displayed along with a description 3703 of the correct location. FIG. 38 shows a different embodiment 3801 in which a dot 3802 appears as the point that a user must identify by selecting one of the answer choices 3803. When the user decides to submit their answer, a choose answer button 3804 or the like is clicked. If a user wishes to change their answer, a reset button 3805 may be clicked.

As discussed above, various subscription models may be used in connection with the present method. Various exemplary choices are shown on web page 3901, in which a user can select a crash course 3902 for a selected number of weeks 3903 at a given price 3904. A buy now button 3905 may display a shopping cart interface or other payment display. Other subscriptions may include 3 month subscriptions 3906, which may be afforded rebates 3907 for bulk purchases and the like. A-La-Cart subscriptions 3908 may also be selected for flat fees such as $145.

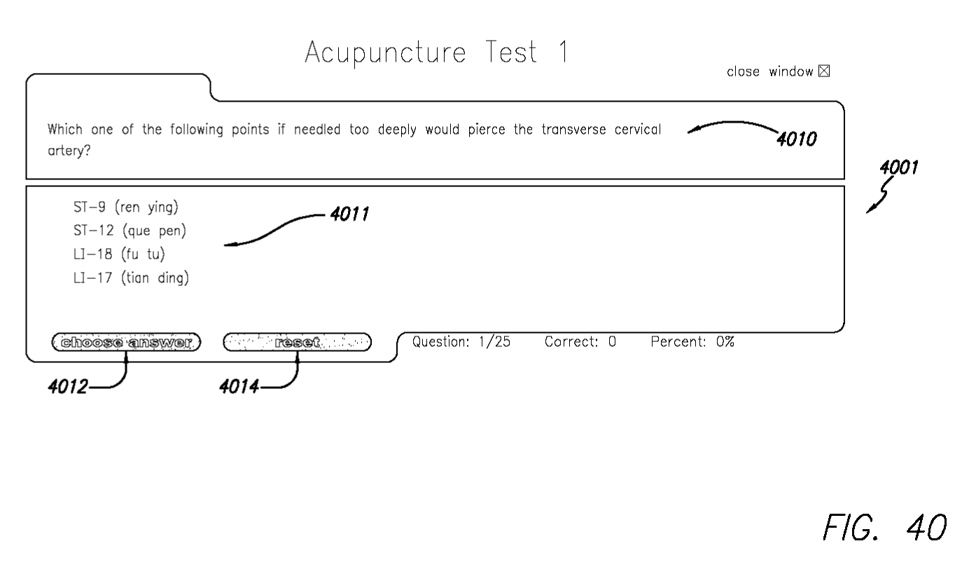

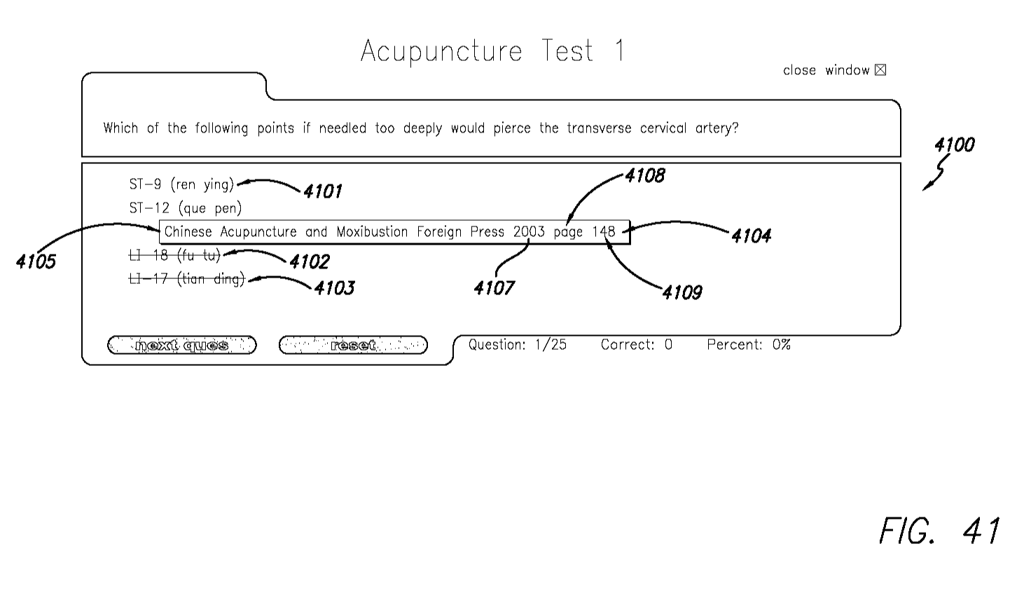

An additional sample questions embodiment is shown in FIG. 40 in display 4001, with a question 4010 displayed and four answer choices 4011 available. An answer can be submitted using a choose answer button 4012 or cancelled using reset button 4014. As shown in FIG. 41, in the event a question is answered incorrectly, an interface 4100 will show each of the incorrect answers 4101, 4102, 4103 in strike through font. The correct answer will be displayed along with an annotation 4104 that may include one or more of a publication or text book title 4105, publisher 4106, year 4107, location identifier, in this example a page 4108, and a page number 4109. Other identification information useful to the user may be displayed as well.

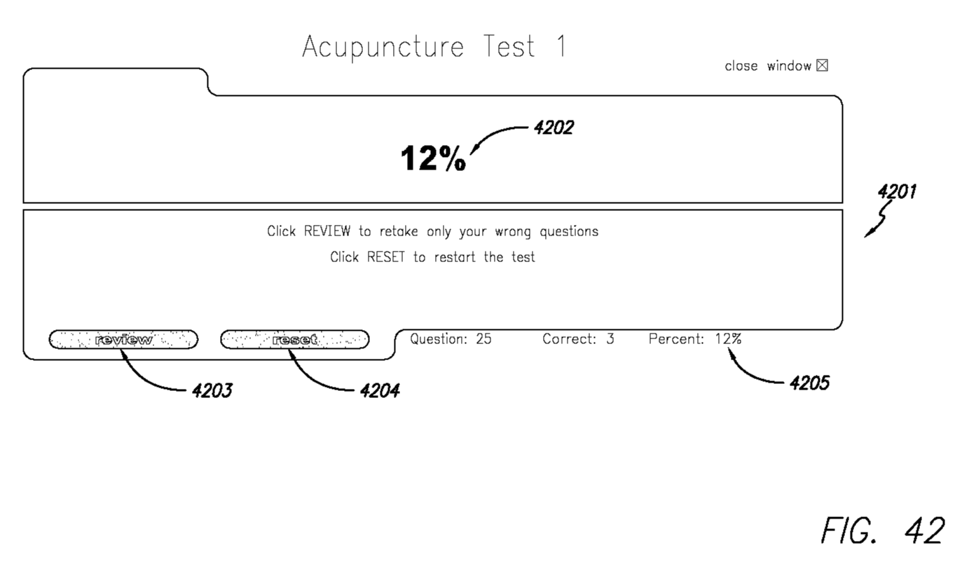

FIG. 42 shows results following completion of a battery of questions 4201 including a correct answer percentage 4202. The user can click review 4203 to retake incorrect questions or reset 4204 to restart the entire test.

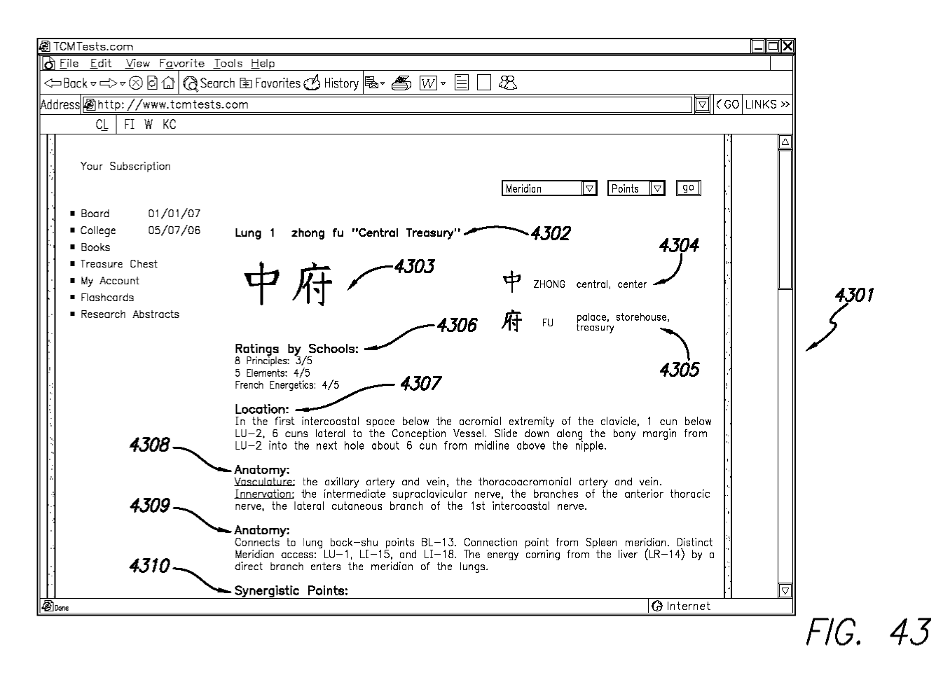

FIG. 43 is an example of additional study information 4301 available through the user interface. Information may include a title 4302, symbol 4303, explanation of symbol parts 4304, 4305, rating by school 4306, location 4307, anatomy information 4308, attributes 4309 and synergistic points, 4310.

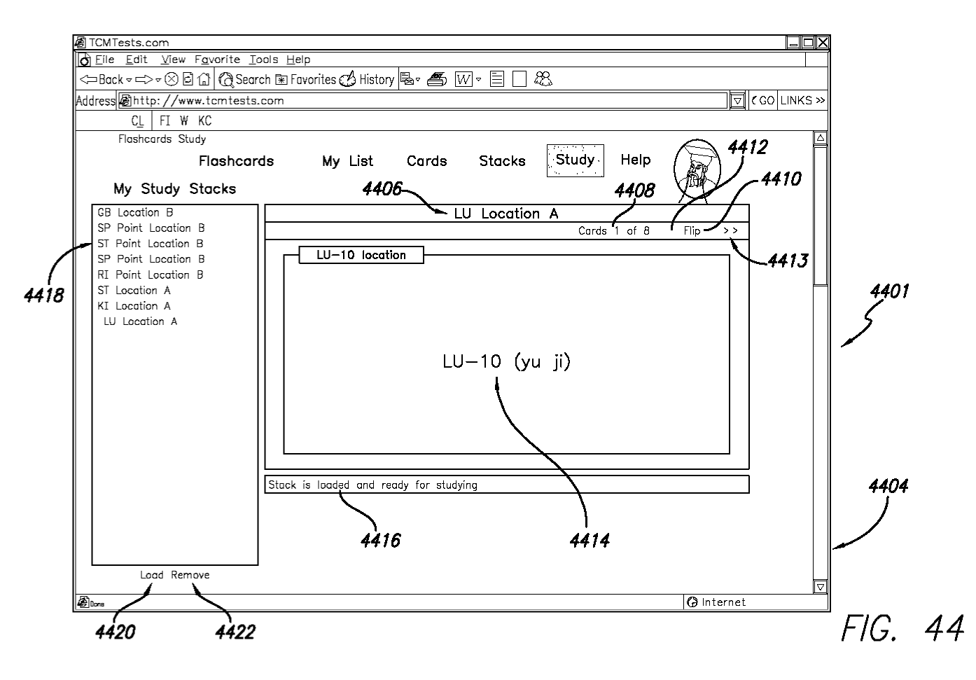

FIG. 44 shows a flashcard interface 4401. Flashcard interface includes a set title 4406, card count 4408, flip button 4410, first card button 4412 and last card button 4413. Additional title information is shown in message 4414. Message 4416 shows a stack of cards is ready for review. Stacks may be selected from the my study stacks section 4418. Individual stacks may be loaded or removed using a load button 4420 and remove button 4422, respectfully.

While the disclosure described herein generally relates to functional features of the system and website, it should be apparent to one skilled in the art that individual web pages may be designed with graphics and/or images related to the field of study and the content of the web page. It should also be apparent that advertising may appear on the website, providing additional revenue to the system operator.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicants have provided description and figures which are intended as illustrations of embodiments of the disclosure, and are not intended to be construed as containing or implying limitation of the disclosure to these embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit ans scope of the present disclosure and the appended claims.

What is claimed is:

1. An interactive method for education and test preparation, the method comprising the steps of:
providing a user interface over a communications network,
displaying an interactive quiz to the user interface, the interactive quiz including at least one question, the question being selected from a database of test question keyed to one of a credential-earning examination and a publication on a topic included in the credential-earning examination;
allowing a user to take the interactive quiz; and
displaying quiz results on the user interface.

2. The method of claim 1, further comprising the at least question being displayed in a multiple choice question format, and allowing a user to select at least one of the choices to select an answer to the question.

3. The method of claim 1, further comprising the credential-earning examination being an examination on one or more of traditional Chinese medicine, acupuncture, herbology, and Asian bodywork therapy.

4. The method of claim 1, further comprising providing a questions database in communication with the user interface, the questions database including a plurality of test questions.

5. The method of claim 4, further comprising the question system including between a thousand and 100,000 test questions.

6. The method of claim 4, further comprising:
storing the questions along with annotations to selected publications, the annotations including one or more of an author, a title, a publisher, a publication date, a chapter reference, a page number reference, a paragraph reference, and a line reference; and
displaying an annotation when a question is answered incorrectly.

7. The method of claim 1, further comprising displaying an anatomical illustration along with a test question, wherein the test question is prompting for identification of a location on the illustration.

8. The method of claim 7, further comprising allowing positioning of a dot on the illustration to answer the test question.

9. The method of claim 7, further comprising, in response to selecting an incorrect answering, identifying the correct answer and displaying an annotation to a publication where the correct answer is described.

10. The method of claim 9, further comprising the annotation showing one or more of a publication title, a chapter, and page number.

11. The method of claim 1, further comprising storing information on one or more of an identification of which test questions were asked, a plurality of answers given, statistics on the number of questions answered correctly, wherein the statistics can be divided into one or more of a question set, a topic, a section of a publication, a chapter of a text book, and section of a credential-earning examination, and a section of a test.

12. An interactive method for education and test preparation, the method comprising the steps of:
providing a user interface over a communications network, the user interface including a plurality of sub-sections for displaying information related to one of a credential-earning examination and a publication on a topic included in the credential-earning examination;
allowing a user to select and use one or more of the sub-sections during the user's preparation for the credential-earning examination;
tracking study statistics about the use by the user; and
displaying the study statistics to the user via the user interface.

13. The method of claim 12, wherein one sub-section of the plurality of sub-sections is a flashcard section, the method further comprising the steps of displaying at least one flashcard displaying at least one of a question and an answer related to the credential-earning examination.

14. The method of claim 12, wherein the sub-sections correspond to a board examination, the sub-sections including one or more of acupuncture, foundations, point location, biomedicine, and herbs.

15. The method of claim 12, further comprising providing the user interface to at least one user on a subscription basis.

16. The method of claim 15, further comprising providing the user interface on a monthly subscription basis.

17. The method of claim 15, further comprising providing the user interface for a period leading up the credential-earning examination.

18. The method of claim 17, further comprising the period being 0-4 months before the credential-earning examination.

19. The method of claim 15, further comprising providing one or more of sample test, a sample quiz, a sample test question, and a daily test question, with a subscription.

20. The method of claim 19, further comprising providing the sample question via email to a subscriber.

21. A computer readable medium having program code stored thereon and being for interactive test preparation and education, the program code, when executed on a computer, causing the computer to:
provide a user interface over a communications network,
display an interactive quiz to the user interface, the interactive quiz including at least one question, the question being selected form a database of test questions keyed to one of a credential-earning examination and a publication on a topic included in the credential-earning examination;
allow a user to take the interactive quiz; and
display quiz results on the user interface.

22. A computer-implemented system for test preparation and education, the system comprising:
at least one general purpose computer operated by a software module operative to:
provide a user interface over a communications network,
display an interactive quiz to the user interface, the interactive quiz including at least one question, the question being selected from a database of test questions keyed to one of a credential-earning examination and a publication on a topic included in the credential-earning examination;
allow a user to take the interactive quiz; and
display quiz results on the user interface; and
a server in communication with the at least one general purpose computer over a communications network, the server storing the database.
